(19) United States
(12) Patent Application Publication
(10) Pub. No.: US 2012/0322961 A1
(43) Pub. Date: Dec. 20, 2012

(54) MULTI-COMPONENT METALLOCENE CATALYST SYSTEMS FOR THE PRODUCTION OF REACTOR BLENDS OF POLYPROPYLENE

(75) Inventors: David J. Rauscher, Angleton, TX (US); Jun Tian, League City, TX (US); William J. Gauthier, Houston, TX (US); Shady N. Henry, Seabrook, TX (US)

(73) Assignee: FINA TECHNOLOGY, INC., Houston, TX (US)

(21) Appl. No.: 13/476,145

(22) Filed: May 21, 2012

Related U.S. Application Data
(60) Provisional application No. 61/497,565, filed on Jun. 16, 2011.

(51) Int. Cl. C08F 4/76; C08F 210/06; C08F 110/06

(52) U.S. Cl. 526/118; 502/152

(57) ABSTRACT

Embodiments of the invention generally include multicomponent catalyst systems, polymerization processes and reactor blends formed by the processes. The multicomponent catalyst system generally includes a first catalyst component and a second catalyst component, wherein the second catalyst component is different from the first catalyst component.

### CROSS-REFERENCE TO RELATED APPLICATIONS

This application claims priority to U.S. Provisional Patent No. 61/497,565 filed on Jun. 16, 2011.

### FIELD

Embodiments of the present invention generally relate to processes and catalyst systems for forming polyolefins. In particular, embodiments relate to multicomponent metallocene catalyst systems for forming blends of polypropylene in-situ. Specifically, embodiments relate to multicomponent metallocene catalyst systems for forming reactor blends of polypropylene or random copolymers of propylene with broadening of molecular weight distribution. Additionally, the catalyst activity may be enhanced.

### BACKGROUND

Metallocene compounds, whether supported or unsupported, can further be characterized in terms of stereoregular catalysts which can facilitate the polymerization of alpha olefins, such as propylene, to produce crystalline stereoregular polymers, the most common of which are isotactic polypropylene and syndiotactic polypropylene. In general, stereospecific metallocene catalysts possess a center structure and one or more ligand structures (usually cyclopentadienyl-based) that are conformationally restricted. The center structure of stereospecific metallocene catalysts is typically chiral in conformation. A chiral object is not superimposible on its mirror image, examples of chiral objects include hands and keys.

Isospecific and syndiospecific metallocene catalysts can be useful in the stereospecific polymerization of monomers. Stereospecific structural relationships of syndiotacticity and isotacticity may be involved in the formation of stereoregular polymers from various monomers. Stereospecific propagation may be applied in the polymerization of ethylenically unsaturated monomers such as C₃ to C₂₀ alpha olefins which can be linear, branched, or cyclic, 1-dienes such as 1,3-butadiene, substituted vinyl compounds such as vinyl aromatics, e.g., styrene or vinyl chloride, vinyl chloride, vinyl ethers such as alkyl vinyl ethers, e.g., isobutyl vinyl ether, or even aryl vinyl ethers. Stereospecific polymer propagation is probably of most significance in the production of polypropylene of isotactic or syndiotactic structure.

The structure of isotactic polypropylene can be described as one having the methyl groups attached to the tertiary carbon atoms of successive monomeric units falling on the same side of a hypothetical plane through the main chain of the polymer, e.g., the methyl groups are all above or below the plane. Using the Fischer projection formula, the stereochemical sequence of isotactic polypropylene can be described as follows:

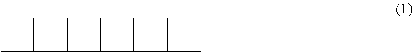

In Formula I each vertical segment indicates a methyl group on the same side of the polymer backbone. In the case of isotactic polypropylene, the majority of inserted propylene units possess the same relative configuration in relation to its neighboring propylene unit. Another way of describing the structure is through the use of NMR. Bovey's NMR nomenclature for an isotactic sequence as shown above is . . . mmmm . . . with each “m” representing a “meso” dyad in which there is a mirror plane of symmetry between two adjacent monomer units, or successive pairs of methyl groups on the same side of the plane of the polymer chain. As is known in the art, any deviation or inversion in the structure of the chain lowers the degree of isotacticity and subsequently the crystallinity of the polymer.

In contrast to the isotactic structure, syndiotactic propylene polymers are those in which the methyl groups attached to the tertiary carbon atoms of successive monomeric units in the chain lie on alternate sides of the plane of the polymer. Syndiotactic polypropylene in using the Fischer projection formula can be indicated by racemic dyads with the syndiotactic sequence . . . rrrr . . . shown as follows:

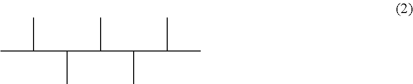

Bovey's NMR nomenclature for a syndiotactic sequence as shown above is . . . rrrr . . . with each “r” representing a “racemic” dyad in which successive pairs of methyl groups are on the opposite sides of the plane of the polymer chain. Similarly, any deviation or inversion in the structure of the chain lowers the degree of syndiotacticity and subsequently the crystallinity of the polymer.

The vertical segments in the preceding example indicate methyl groups in the case of syndiotactic or isotactic polypropylene. Other terminal groups, e.g. ethyl, in the case of polyl-butene, chloride, in the case of polyvinyl chloride, or phenyl groups in the case of polystyrene and so on can be equally described in this fashion as either isotactic or syndiotactic.

A polymer is “atactic” when its pendant groups are arranged in a random fashion on both sides of the chain of the polymer.

Reducing per pound resin manufacturing cost for the production of metallocene polypropylene may be achieved through increasing catalyst activity.

Narrow molecular weight distribution of miPP metallocene random copolymers (mRCP) can result in resins that are tough to process (high power input, shark skin and melt fracture, etc.).

Therefore, a need exists for a process of producing miPP and mRCP that reduces the cost of production through increased catalyst activity and broadening the molecular weight distribution for better processability of the resulting resin.

### SUMMARY

Embodiments of the invention generally include multicomponent catalyst systems. The multicomponent catalyst system generally includes a first catalyst component selected from a metallocene catalyst represented by the general formula XCp^{A}Cp^{B}MAₙ, wherein X is a structural bridge, Cp^{A} and Cp^{B} each denote a cyclopentadienyl group or derivatives thereof, each being the same or different and which may be either substituted or unsubstituted, M is a transition metal and A is an alkyl, hydrocarbyl or halogen group and n is an integer between 0 and 4. The multicomponent catalyst system further includes a second catalyst component generally represented by the formula XCp^{A}Cp^{B}MAₙ, wherein X is a structural bridge, Cp^{A} and Cp^{B} each denote a cyclopentadienyl group or derivatives thereof, each being the same or different and which may be either substituted or unsubstituted, M is a transition metal and A is an alkyl, hydrocarbyl or halogen group and n is an integer between 0 and 4. The first and second catalyst components are different.

One embodiment includes a process further including introducing the multicomponent metallocene catalyst system to a reaction zone, introducing an olefin monomer to the reaction zone and contacting the multicomponent catalyst system with the olefin monomer to form a polyolefin.

Embodiments further include the introduction of a second olefin monomer into a reaction zone, resulting in a random copolymer.

### BRIEF DESCRIPTION OF DRAWINGS

FIG. 1 illustrates the effect of ‘n’ metallocene content in the supported catalysts on the polymerization activity and fluff bulk density (2.0 wt % in total).

FIG. 2 illustrates the effect of ‘m’ metallocene content in the supported catalysts on the fluff melt flow.

FIG. 3 illustrates the effect of metallocene loading in the supported catalysts (‘m’/‘n’=1.5/1.0) on the polymerization activity and fluff bulk density.

FIG. 4 illustrates the bulk density of polypropylene fluffs from ‘m+n’ (‘m’:‘n’=1.5:1.0) catalysts with different initial hydrogen concentration.

FIG. 5 illustrates the propylene polymerization activities of MAO/P10 supported catalysts with different metallocene mixing ratio (loading 2.0 wt %) under different initial hydrogen concentrations.

FIG. 6 illustrates the melt flow of polypropylene fluffs from MAO/P 10 supported catalysts with different metallocene mixing ratios (loading 2.0 wt %) under different initial hydrogen concentration.

FIG. 7 illustrates the bulk density of polypropylene fluffs from MAO/P10 supported catalyst with different metallocene mixing ratios (loading 2.0 wt %) under different initial hydrogen concentration.

FIG. 8 is a gel permeation chromatograph of polypropylene resin from ‘m+n’ catalysts with different mixing ratio.

FIG. 9 illustrates the polydispersity of polypropylene resins from MAO/P10 supported catalysts with different metallocene mixing ratios but the same loading (2.0 wt %) under different initial hydrogen concentration.

FIG. 10 illustrates the molecular weights and its distribution of polypropylene resins from ‘m+n’ (‘m’:‘n’=1.5:1.0) catalysts with different metallocene loadings.

FIG. 11 is a gel permeation chromatograph of polypropylene resins from ‘m+n’ (‘m’:‘n’=1.5:1.0) catalysts with different initial hydrogen concentrations.

FIG. 12 a gel permeation chromatograph of polypropylene resins from ‘m+n’ (‘m’:‘n’=1.5:1.0) catalysts with different initial hydrogen concentrations.

FIG. 13 illustrates the melt flow of polymer fluffs from both ‘m+n’ and ‘m’+‘n’ MAO/P10 supported catalysts with different ‘m’:‘n’ ratios.

FIG. 14 illustrates the molecular weight distribution of polymer fluffs from both ‘m+n’ and ‘m’+‘n’ MAO/P 10 supported catalysts with different ‘m’:‘n’ ratios.

FIG. 15 is a comparison of ethylene copolymerization behavior of miPP catalysts.

FIG. 16 is a comparison of ethylene incorporation rates for m, n, and AR35 catalysts.

FIG. 17 is a comparison of crystallinity as a function of peak melting temperature

FIG. 18 illustrates the relationship between xylene soluble and copolymer melting temperature.

### DETAILED DESCRIPTION

### Introduction and Definitions

A detailed description will now be provided. Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims. Each of the inventions will now be described in greater detail below, including specific embodiments, versions and examples, but the inventions are not limited to these embodiments, versions or examples, which are included to enable a person having ordinary skill in the art to make and use the inventions when the information in this patent is combined with available information and technology.

Various terms as used herein are shown below. To the extent a term used in a claim is not defined below, it should be given the broadest definition persons in the pertinent art have given that term as reflected in printed publications and issued patents. Further, unless otherwise specified, all compounds described herein may be substituted or unsubstituted and the listing of compounds includes derivatives thereof.

Various ranges are further recited below. It should be recognized that unless stated otherwise, it is intended that the endpoints are to be interchangeable. Further, any point within that range is contemplated as being disclosed herein.

The term “activity” refers to the weight of product produced per weight of the catalyst used in a process at a standard set of conditions per unit time.

As used herein, the term “activator” is defined to be any compound or combination of compounds, supported or unsupported, which may enhance the activity and/or productivity of a catalyst compound.

### Catalyst Systems

Certain polymerization processes disclosed herein involve contacting olefin monomers with a multicomponent metallocene catalyst composition, sometimes also referred to herein as simply a multicomponent catalyst. As used herein, the terms “multicomponent catalyst composition” and “multicomponent catalyst” refer to any composition, mixture or system that includes at least two different catalyst compounds. Although it is contemplated that the multicomponent catalyst can include more than two different catalysts, for purposes of discussing the invention herein, only two of those catalyst compounds are described in detail herein (i.e., the “first catalyst component” and the “second catalyst component”).

### First Catalyst Component

The multicomponent catalyst compositions described herein include a “first catalyst component”. The first catalyst component generally includes catalyst systems known to one skilled in the art. For example, the first catalyst component may include metallocene catalyst systems, single site catalyst systems, or combinations thereof, for example. A brief discussion of such catalyst systems is included below, but is in no way intended to limit the scope of the invention to such catalysts.

Metallocene catalysts may be characterized generally as coordination compounds incorporating one or more cyclopentadienyl (Cp) groups (which may be substituted or unsubstituted, each substitution being the same or different) coordinated with a transition metal through π bonding.

The substituent groups on Cp may be linear, branched or cyclic hydrocarbyl radicals, for example. The inclusion of cyclic hydrocarbyl radicals may transform the Cp into other contiguous ring structures, such as indenyl, azulenyl and fluorenyl groups, for example. These contiguous ring structures may also be substituted or unsubstituted by hydrocarbyl radicals, such as C₁ to C₂₀ hydrocarbyl radicals, for example.

A specific, non-limiting, example of a metallocene catalyst is a bulky ligand metallocene compound generally represented by the formula:

[L]ₘM[A]ₙ;

wherein L is a bulky ligand, A is a leaving group, M is a transition metal and m and n are such that the total ligand valency corresponds to the transition metal valency. For example m may be from 1 to 4 and n may be from 1 to 3.

The metal atom “M” of the metallocene catalyst compound, as described throughout the specification and claims, may be selected from Groups 3 through 12 atoms and lanthanide Group atoms, or from Groups 3 through 10 atoms or from Sc, Ti, Zr, Hf, V, Nb, Ta, Mn, Re, Fe, Ru, Os, Co, Rh, Ir and Ni. The oxidation state of the metal atom “M” may range from 0 to +7 or is +1, +2, +3, +4 or +5, for example.

The bulky ligand generally includes a cyclopentadienyl group (Cp) or a derivative thereof. The Cp ligand(s) form at least one chemical bond with the metal atom M to form the “metallocene catalyst.” The Cp ligands are distinct from the leaving groups bound to the catalyst compound in that they are not highly susceptible to substitution/abstraction reactions.

Cp ligands may include ring(s) or ring system(s) including atoms selected from group 13 to 16 atoms, such as carbon, nitrogen, oxygen, silicon, sulfur, phosphorous, germanium, boron, aluminum and combinations thereof, wherein carbon makes up at least 50% of the ring members. Non-limiting examples of the ring or ring systems include cyclopentadienyl, cyclopentaphenanthreneyl, indenyl, benzindenyl, fluorenyl, tetrahydroindenyl, octahydrofluorenyl, cyclooctatetraenyl, cyclopentacyclododecene, phenanthrindenyl, 3,4-benzofluorenyl, 9-phenylfluorenyl, 8-H-cyclopent[α]acenaphthylenyl, 7-H-dibenzofluorenyl, indeno[1,2-9]anthrene, thiophenoindenyl, thiophenofluorenyl, hydrogenated versions thereof (e.g., 4,5,6,7-tetrahydroindenyl or “H₄Ind”), substituted versions thereof and heterocyclic versions thereof, for example.

Cp substituent groups may include hydrogen radicals, alkyls (e.g., methyl, ethyl, propyl, butyl, pentyl, hexyl, fluoromethyl, fluoroethyl, difluoroethyl, iodopropyl, bromohexyl, benzyl, phenyl, methylphenyl, tert-butylphenyl, chlorobenzyl, dimethylphosphine and methylphenylphosphine), alkenyls (e.g., 3-butenyl, 2-propenyl and 5-hexenyl), alkynyls, cycloalkyls (e.g., cyclopentyl and cyclohexyl), aryls (e.g., trimethylsilyl, trimethylgermyl, methyldiethylsilyl, acyls, aroyls, tris(trifluoromethyl)silyl, methylbis(difluoromethyl)silyl and bromomethyldimethylgermyl), alkoxys (e.g., methoxy, ethoxy, propoxy and phenoxy), aryloxys, alkylthiols, dialkylamines (e.g., dimethylamine and diphenylamine), alkylamidos, alkoxycarbonyls, aryloxycarbonyls, carbomoyls, alkyl- and dialkyl-carbamoyls, acyloxys, acylaminos, aroylaminos, organometalloid radicals (e.g., dimethylboron), Group 15 and Group 16 radicals (e.g., methylsulfide and ethylsulfide) and combinations thereof, for example. In one embodiment, at least two substituent groups, two adjacent substituent groups in one embodiment, are joined to form a ring structure.

Each leaving group “A” is independently selected and may include any ionic leaving group, such as halogens (e.g., chloride and fluoride), hydrides, C₁ to C₁₂ alkyls (e.g., methyl, ethyl, propyl, phenyl, cyclobutyl, cyclohexyl, heptyl, tolyl, trifluoromethyl, methylphenyl, dimethylphenyl and trimethylphenyl), C₂ to C₁₂ alkenyls (e.g., C₂ to C₆ fluoroalkenyls), C₆ to C₁₂ aryls (e.g., C₇ to C₂₀ alkylaryls), C₁ to C₁₂ alkoxys (e.g., phenoxy, methyoxy, ethyoxy, propoxy and benzoxy), C₆ to C₁₆ aryloxys, C₇ to C₁₈ alkylaryloxys and C₁ to C₁₂ heteroatom-containing hydrocarbons and substituted derivatives thereof, for example.

Other non-limiting examples of leaving groups include amines, phosphines, ethers, carboxylates (e.g., C₁ to C₆ alkylcarboxylates, C₆ to C₁₂ arylcarboxylates and C₇ to C₁₈ alkylarylcarboxylates), dienes, alkenes (e.g., tetramethylene, pentamethylene, methylidene), hydrocarbon radicals having from 1 to 20 carbon atoms (e.g., pentafluorophenyl) and combinations thereof, for example. In one embodiment, two or more leaving groups form a part of a fused ring or ring system.

In a specific embodiment, L and A may be bridged to one another to form a bridged metallocene catalyst. A bridged metallocene catalyst, for example, may be described by the general formula:

XCp^{A}Cp^{B}MAₙ;

wherein X is a structural bridge, Cp^{A} and Cp^{B} each denote a cyclopentadienyl group or derivatives thereof, each being the same or different and which may be either substituted or unsubstituted, M is a transition metal and A is an alkyl, hydrocarbyl or halogen group and n is an integer between 0 and 4, and either 1 or 2 in a particular embodiment.

Non-limiting examples of bridging groups “X” include divalent hydrocarbon groups containing at least one Group 13 to 16 atom, such as, but not limited to, at least one of a carbon, oxygen, nitrogen, silicon, aluminum, boron, germanium, tin and combinations thereof; wherein the heteroatom may also be a C₁ to C₁₂ alkyl or aryl group substituted to satisfy a neutral valency. The bridging group may also contain substituent groups as defined above including halogen radicals and iron. More particular non-limiting examples of bridging group are represented by C₁ to C₆ alkylenes, substituted C₁ to C₆ alkylenes, oxygen, sulfur, R₂C═, R₂Si═, —Si(R)₂Si(R₂)—, R₂Ge═ or RP═ (wherein “═” represents two chemical bonds), where R is independently selected from hydrides, hydrocarbyls, halocarbyls, hydrocarbyl-substituted organometalloids, halocarbyl-substituted organometalloids, disubstituted boron atoms, disubstituted Group 15 atoms, substituted Group 16 atoms and halogen radicals, for example. In one embodiment, the bridged metallocene catalyst component has two or more bridging groups.

Other non-limiting examples of bridging groups include methylene, ethylene, ethylidene, propylidene, isopropylidene, diphenylmethylene, 1,2-dimethylethylene, 1,2-diphenylethylene, 1,1,2,2-tetramethylethylene, dimethylsilyl, diethylsilyl, methyl-ethylsilyl, trifluoromethylbutylsilyl, bis(trifluoromethyl)silyl, di(n-butyl)silyl, di(n-propyl)silyl, di(1-propyl)silyl, di(n-hexyl)silyl, dicyclohexylsilyl, diphenylsilyl, cyclohexylphenylsilyl, t-butylcyclohexylsilyl, di(t-butylphenyl)silyl, di(p-tolyl)silyl and the corresponding moieties, wherein the Si atom is replaced by a Ge or a C atom; dimethylsilyl, diethylsilyl, dimethylgermyl and/or diethylgermyl.

In another embodiment, the bridging group may also be cyclic and include 4 to 10 ring members or 5 to 7 ring members, for example. The ring members may be selected from the elements mentioned above and/or from one or more of boron, carbon, silicon, germanium, nitrogen and oxygen, for example. Non-limiting examples of ring structures which may be present as or part of the bridging moiety are cyclobutylidene, cyclopentylidene, cyclohexylidene, cycloheptylidene, cyclooctylidene, for example. The cyclic bridging groups may be saturated or unsaturated and/or carry one or more substituents and/or be fused to one or more other ring structures. The one or more Cp groups which the above cyclic bridging moieties may optionally be fused to may be saturated or unsaturated. Moreover, these ring structures may themselves be fused, such as, for example, in the case of a naphthyl group.

In one embodiment, the metallocene catalyst includes CpFlu Type catalysts (e.g., a metallocene catalyst wherein the ligand includes a Cp fluorenyl ligand structure) represented by the following formula:

X(CpR¹ₙR²ₘ)(FlR³ₚ);

wherein Cp is a cyclopentadienyl group or derivatives thereof, Fl is a fluorenyl group, X is a structural bridge between Cp and Fl, R¹ is an optional substituent on the Cp, n is 1 or 2, R² is an optional substituent on the Cp bound to a carbon immediately adjacent to the ipso carbon, m is 1 or 2 and each R³ is optional, may be the same or different and may be selected from C₁ to C₂₀ hydrocarbyls. In one embodiment, at least one R³ is substituted in the para position on the fluorenyl group and at least one other R³ being substituted at an opposed para position on the fluorenyl group and p is 2 or 4.

In yet another aspect, the metallocene catalyst includes bridged mono-ligand metallocene compounds (e.g., mono cyclopentadienyl catalyst components). In this embodiment, the metallocene catalyst is a bridged “half-sandwich” metallocene catalyst. In yet another aspect of the invention, the at least one metallocene catalyst component is an unbridged “half sandwich” metallocene. (See, U.S. Pat. No. 6,069,213, U.S. Pat. No. 5,026,798, U.S. Pat. No. 5,703,187, U.S. Pat. No. 5,747,406, U.S. Pat. No. 5,026,798 and U.S. Pat. No. 6,069,213, which are incorporated by reference herein.)

Non-limiting examples of metallocene catalyst components consistent with the description herein include, for example cyclopentadienylzirconiumAₙ; indenylzirconiumAₙ; (1-methylindenyl)zirconiumAₙ; (2-methylindenyl)zirconiumAₙ, (1-propylindenyl)zirconiumAₙ; (2-propylindenyl)zirconiumAₙ; (1-butylindenyl)zirconiumAₙ; (2-butylindenyl)zirconiumAₙ; methylcyclopentadienylzirconiumAₙ; tetrahydroindenylzirconiumAₙ; pentamethylcyclopentadienylzirconiumAₙ; cyclopentadienylzirconiumAₙ; pentamethylcyclopentadienyltitaniumAₙ; tetramethylcyclopentyltitaniumAₙ; (1,2,4-trimethylcyclopentadienyl)zirconiumAₙ; dimethylsilyl(1,2,3,4-tetramethylcyclopentadienyl)(cyclopentadienyl)zirconiumAₙ; dimethylsilyl(1,2,3,4-tetramethylcyclopentadienyl)(1,2,3-trimethylcyclopentadienyl)zirconiumAₙ; dimethylsilyl(1,2,3,4-tetramethylcyclopentadienyl)(1,2-dimethylcyclopentadienyl)zirconiumAₙ; dimethylsilyl(1,2,3,4-tetramethylcyclopentadienyl)(2-methylcyclopentadienyl)zirconiumAₙ; dimethylsilylcyclopentadienylindenylzirconiumAₙ; dimethylsilyl(2-methylindenyl)(fluorenyl)zirconiumAₙ; diphenylsilyl(1,2,3,4-tetramethylcyclopentadienyl)(3-propylcyclopentadienyl)zirconiumAₙ; dimethylsilyl (1,2,3,4-tetramethylcyclopentadienyl) (3-t-butylcyclopentadienyl)zirconiumAₙ; dimethylgermyl(1,2-dimethylcyclopentadienyl)(3-isopropylcyclopentadienyl)zirconiumAₙ; dimethylsilyl(1,2,3,4-tetramethylcyclopentadienyl)(3-methylcyclopentadienyl)zirconiumAₙ; diphenylmethylidene(cyclopentadienyl)(9-fluorenyl)zirconiumAₙ; diphenylmethylidenecyclopentadienylindenylzirconiumAₙ; isopropylidenebiscyclopentadienylzirconiumAₙ; isopropylidene(cyclopentadienyl)(9-fluorenyl)zirconiumAₙ; isopropylidene(3-methylcyclopentadienyl)(9-fluorenyl)zirconiumAₙ; ethylenebis(9-fluorenyl)zirconiumAₙ; ethylenebis(1-indenyl)zirconiumAₙ; ethylenebis(1-indenyl)zirconiumAₙ; ethylenebis(2-methyl-1-indenyl)zirconiumAₙ; ethylenebis(2-methyl-4,5,6,7-tetrahydro-1-indenyl)zirconiumAₙ; ethylenebis(2-propyl-4,5,6,7-tetrahydro-1-indenyl)zirconiumAₙ; ethylenebis(2-isopropyl-4,5,6,7-tetrahydro-1-indenyl)zirconiumAₙ; ethylenebis(2-butyl-4,5,6,7-tetrahydro-1-indenyl)zirconiumAₙ; ethylenebis(2-isobutyl-4,5,6,7-tetrahydro-1-indenyl)zirconiumAₙ; dimethylsilyl(4,5,6,7-tetrahydro-1-indenyl)zirconiumAₙ; diphenyl(4,5,6,7-tetrahydro-1-indenyl)zirconiumAₙ; ethylenebis(4,5,6,7-tetrahydro-1-indenyl)zirconiumAₙ; dimethylsilylbis(cyclopentadienyl)zirconiumAₙ; dimethylsilylbis(9-fluorenyl)zirconiumAₙ; dimethylsilylbis(1-indenyl)zirconiumAₙ; dimethylsilylbis(2-methylindenyl)zirconiumAₙ; dimethylsilylbis(2-propylindenyl)zirconiumAₙ; dimethylsilylbis(2-butylindenyl)zirconiumAₙ; diphenylsilylbis(2-methylindenyl)zirconiumAₙ; diphenylsilylbis(2-propylindenyl)zirconiumAₙ; diphenylsilylbis(2-butylindenyl)zirconiumAₙ; dimethylgermylbis(2-methylindenyl)zirconiumAₙ; dimethylsilylbistetrahydroindenylzirconiumAₙ; dimethylsilylbistetramethylcyclopentadienylzirconiumAₙ; dimethylsilyl(cyclopentadienyl)(9-fluorenyl)zirconiumAₙ; diphenylsilyl(cyclopentadienyl)(9-fluorenyl)zirconiumAₙ; diphenylsilylbisindenylzirconiumAₙ; cyclotrimethylenesilyltetramethylcyclopentadienylcyclopentadienylzirconiumAₙ; cyclotetramethylenesilyltetramethylcyclopentadienylcyclopentadienylzirconiumAₙ; cyclotrimethylenesilyktetramethylcyclopentadienyl)(2-methylindenyl)zirconiumAₙ; cyclotrimethylenesilyktetramethylcyclopentadienyl)(3-methylcyclopentadienyl)zirconiumAₙ; cyclotrimethylenesilylbis(2-methylindenyl)zirconiumAₙ; cyclotrimethylenesilyl(tetramethylcyclopentadienyl)(2,3,5-trimethylclopentadienyl)zirconiumAₙ; cyclotrimethylenesilylbis(tetramethylcyclopentadienyl)zirconiumAₙ; dimethylsilyktetramethylcyclopentadieneyl)(N-tertbutylamido)titaniumAₙ; biscyclopentadienylchromiumAₙ; biscyclopentadienylzirconiumAₙ; bis(n-butylcyclopentadienyl)zirconiumAₙ; bis(n-dodecyclcyclopentadienyl)zirconiumAₙ; bisethylcyclopentadienylzirconiumAₙ; bisisobutylcyclopentadienylzirconiumAₙ; bisisopropylcyclopentadienylzirconiumAₙ; bismethylcyclopentadienylzirconiumAₙ; bisoctylcyclopentadienylzirconiumAₙ; bis(n-pentylcyclopentadienyl)zirconiumAₙ; bis(n-propylcyclopentadienyl)zirconiumAₙ; bistrimethylsilylcyclopentadienylzirconiumAₙ; bis(1,3-bis(trimethylsilyl)cyclopentadienyl)zirconiumAₙ; bis(1-ethyl-2-methylcyclopentadienyl)zirconiumAₙ; bis(1-ethyl-3-methylcyclopentadienyl)zirconiumAₙ; bispentamethylcyclopentadienylzirconiumAₙ; bispentamethylcyclopentadienylzirconiumAₙ; bis(1-propyl-3-methylcyclopentadienyl)zirconiumAₙ; bis(1-n-butyl-3-methylcyclopentadienyl)zirconiumAₙ; bis(1-isobutyl-3-methylcyclopentadienyl)zirconiumAₙ; bis(1-propyl-3-butylcyclopentadienyl)zirconiumAₙ; bis(1,3-n-butylcyclopentadienyl)zirconiumAₙ; bis(4,7-dimethylindenyl)zirconiumAₙ; bisindenylzirconiumAₙ; bis(2-methylindenyl)zirconiumAₙ; cyclopentadienylindenylzirconiumAₙ; bis(n-propylcyclopentadienyl)hafniumAₙ; bis(n-butylcyclopentadienyl)hafniumAₙ; bis(n-pentylcyclopentadienyl)hafniumAₙ; (n-propylcyclopentadienyl)(n-butylcyclopentadienyl)hafniumAₙ; bis[(2-trimethylsilylethyl)cyclopentadienyl]hafniumAₙ; bis(trimethylsilylcyclopentadienyl)hathiumAₙ; bis(2-n-propylindenyl)hathiumAₙ; bis(2-n-butylindenyl)hafniumAₙ; dimethylsilylbis(n-propylcyclopentadienyl)hafniumAₙ; dimethylsilylbis(n-butylcyclopentadienyl)hafniumAₙ; bis(9-n-propylfluorenyl)hafniumAₙ; bis(9-n-butylfluorenyl)hathiumAₙ; (9-n-propylfluorenyl)(2-n-propylindenyl)hafniumAₙ; bis(1-n-propyl-2-methylcyclopentadienyl)hathiumAₙ; (n-propylcyclopentadienyl)(1-n-propyl-3-n-butylcyclopentadienyl)hafniumAₙ; dimethylsilyltetramethylcyclopentadienylcyclopropylamidotitaniumAₙ; dimethylsilyltetramethyleyclopentadienylcyclobutylamidotitaniumAₙ; dimethylsilyltetramethyleyclopentadienylcyclopentylamidotitaniumAₙ; dimethylsilyltetramethylcyclopentadienylcyclohexylamidotitaniumAₙ; dimethylsilyltetramethylcyclopentadienylcycloheptylamidotitaniumAₙ; dimethylsilyltetramethylcyclopentadienylcyclooctylamidotitaniumAₙ; dimethylsilyltetramethylcyclopentadienylcyclononylamidotitaniumAₙ; dimethylsilyltetramethylcyclopentadienylcyclodecylamidotitaniumAₙ; dimethylsilyltetramethylcyclopentadienylcycloundecylamidatitaniumAₙ; dimethylsilyltetramethylcyclopentadienylcyclododecylamidotitaniumAₙ; dimethylsilyltetramethylcyclopentadienyhsec-butylamido)titaniumAₙ; dimethylsilyhtetramethylcyclopentadienyl)(n-octylamido)titaniumAₙ; dimethylsilyhtetramethylcyclopentadienyl)(n-decylamido)titaniumAₙ; dimethylsilyhtetramethylcyclopentadienyl)(n-octadecylamido)titaniumAₙ; dimethylsilylbis(cyclopentadienyl)zirconiumAₙ; dimethylsilylbis(tetramethylcyclopentadienyl)zirconiumAₙ; dimethylsilylbis(methylcyclopentadienyl)zirconiumAₙ; dimethylsilylbis(dimethylcyclopentadienyl)zirconiumAₙ; dimethylsilyl(2,4-dimethylcyclopentadienyl) (3′,5′-dimethylcyclopentadienyl)zirconiumAₙ; dimethylsilyl(2,3,5-trimethylcyclopentadienyl)(2′,4′,5′-dimethylcyclopentadienyl)zirconiumAₙ; dimethylsilylbis(t-butylcyclopentadienyl)zirconiumAₙ; dimethylsilylbis(trimethylsilylcyclopentadienyl)zirconiumAₙ; dimethylsilylbis(2-trimethylsilyl-4-t-butylcyclopentadienyl)zirconiumAₙ; dimethylsilylbis(4,5,6,7-tetrahydro-indenyl)zirconiumAₙ; dimethylsilylbis(indenyl)zirconiumAₙ; dimethylsilylbis(2-methylindenyl)zirconiumAₙ; dimethylsilylbis(2,4-dimethylindenyl)zirconiumAₙ; dimethylsilylbis(2,4,7-trimethylindenyl)zirconiumAₙ; dimethylsilylbis(2-methyl-4-phenylindenyl)zirconiumAₙ; dimethylsilylbis(2-ethyl-4-phenylindenyl)zirconiumAₙ; dimethylsilylbis(benz[e]indenyl)zirconiumAₙ; dimethylsilylbis(2-methylbenz[e]indenyl)zirconiumAₙ; dimethylsilylbis(benz[f]indenyl)zirconiumAₙ; dimethylsilylbis(2-methylbenz[f]indenyl)zirconiumAₙ; dimethylsilylbis(3-methylbenz[f]indenyl)zirconiumAₙ; dimethylsilylbis(cyclopenta[cd]indenyl)zirconiumAₙ; dimethylsilylbis(cyclopentadienyl)zirconiumAₙ; dimethylsilylbis(tetramethylcyclopentadienyl)zirconiumAₙ; dimethylsilylbis(methylcyclopentadienyl)zirconiumAₙ; dimethylsilylbis(dimethylcyclopentadienyl)zirconiumAₙ; isopropylidene(cyclopentadienyl-fluorenyl)zirconiumAₙ; isopropylidene(cyclopentadienyl-indenyl)zirconiumAₙ; isopropylidene(cyclopentadienyl-2,7-di-t-butylfluorenyl)zirconiumAₙ; isopropylidene(cyclopentadienyl-3-methylfluorenyl)zirconiumAₙ; isoropylidene(cyclopentadienyl-4-methylfluorenyl)zirconiumAₙ; isopropylidene(cyclopentadienyl-octahydrofluorenyl)zirconiumAₙ; isopropylidene(methylcyclopentadienyl-fluorenyl)zirconiumAₙ; isopropylidene(dimethylcyclopentadienylfluorenyl)zirconiumAₙ; isopropylidene(tetramethylcyclopentadienyl-fluorenyl)zirconiumAₙ; diphenylmethylene(cyclopentadienyl-fluorenyl)zirconiumAₙ; diphenylmethylene(cyclopentadienyl-indenyl)zirconiumAₙ; diphenylmethylene(cyclopentadienyl-2,7-di-t-butylfluorenyl)zirconiumAₙ; diphenylmethylene(cyclopentadienyl-3-methylfluorenyl)zirconiumAₙ; diphenylmethylene(cyclopentadienyl-4-methylfluorenyl)zirconiumAₙ; diphenylmethylene(cyclopentadienyloctahydrofluorenyl)zirconiumAₙ; diphenylmethylene(methylcyclopentadienyl-fluorenyl)zirconiumAₙ; diphenylmethylene(dimethylcyclopentadienyl-fluorenyl)zirconiumAₙ; diphenylmethylene(tetramethylcyclopentadienyl-fluorenyl)zirconiumAₙ; cyclohexylidene (cyclopentadienyl-fluorenyl)zirconiumAₙ; cyclohexylidene (cyclopentadienylindenyl)zirconiumAₙ; cyclohexylidene(cyclopentadienyl-2,7-di-t-butylfluorenyl)zirconiumAₙ; cyclohexylidene(cyclopentadienyl-3-methylfluorenyl)zirconiumAₙ; cyclohexylidene(cyclopentadienyl-4-methylfluorenyl)zirconiumAₙ; cyclohexylidene(cyclopentadienyloctahydrofluorenyl)zirconiumAₙ; cyclohexylidene(methylcyclopentadienylfluorenyl)zirconiumAₙ; cyclohexylidene(dimethylcyclopentadienyl-fluorenyl)zirconiumAₙ; cyclohexylidene(tetramethylcyclopentadienylfluorenyl)zirconiumAₙ; dimethylsilyl(cyclopentadienyl-fluorenyl)zirconiumAₙ; dimethylsilyl(cyclopentadienyl-indenyl)zirconiumAₙ; dimethylsilyl(cyclopentdienyl-2,7-di-t-butylfluorenyl)zirconiumAₙ; dimethylsilyl(cyclopentadienyl-3-methylfluorenyl)zirconiumAₙ; dimethylsilyl(cyclopentadienyl-4-methylfluorenyl)zirconiumAₙ; dimethylsilyl(cyclopentadienyl-octahydrofluorenyl)zirconiumAₙ; dimethylsilylmethylcyclopentanedienyl-fluorenyl)zirconiumAₙ; dimethylsilyhdimethylcyclopentadienylfluorenyl)zirconiumAₙ; dimethylsilyhtetramethylcyclopentadienylfluorenyl)zirconiumAₙ; isopropylidene(cyclopentadienyl-fluorenyl)zirconiumAₙ; isopropylidene(cyclopentadienyl-indenyl)zirconiumAₙ; isopropylidene(cyclopentadienyl-2,7-di-t-butylfluorenyl)zirconiumAₙ; cyclohexylidene(cyclopentadienylfluorenyl)zirconiumAₙ; cyclohexylidene(cyclopentadienyl-2,7-di-t-butylfluorenyl)zirconiumAₙ; dimethylsilyl(cyclopentadienylfluorenyl)zirconiumAₙ; methylphenylsilyltetramethylcyclopentadienylcyclopropylamidotitaniumAₙ; methylphenylsilyltetramethylcyclopentadienylcyclobutylamidotitaniumAₙ; methylphenylsilyltetramethylcyclopentadienylcyclopentylamidotitaniumAₙ; methylphenylsilyltetramethylcyclopentadienylcyclohexylamidotitaniumAₙ; methylphenylsilyltetramethylcyclopentadienylcycloheptylamidotitaniumAₙ; methylphenylsilyltetramethylcyclopentadienylcyclooctylamidotitaniumAₙ; methylphenylsilyltetramethylcyclopentadienylcyclononylamidotitaniumAₙ; methylphenylsilyltetramethylcyclopentadienylcyclodecylamidotitaniumAₙ; methylphenylsilyltetramethylcyclopentadienylcycloundecylamidotitaniumAₙ; methylphenylsilyltetramethylcyclopentadienylcyclododecylamidotitaniumAₙ; methylphenylsilyktetramethylcyclopentadienyl)(sec-butylamido)titaniumAₙ; methylphenylsilyktetramethylcyclopentadienyl)(n-octylamido)titaniumAₙ; methylphenylsilyktetramethylcyclopentadienyl)(n-decylamido)titaniumAₙ; methylphenylsilyktetramethylcyclopentadienyl)(n-octadecylamido)titaniumAₙ; diphenylsilyltetramethylcyclopentadienylcyclopropylamidotitaniumAₙ; diphenylsilyltetramethylcyclopentadienylcyclobutylamidotitaniumAₙ; diphenylsilyltetramethylcyclopentadienylcyclopentylamidotitaniumAₙ; diphenylsilyltetramethylcyclopentadienylcyclohexylamidotitaniumAₙ; diphenylsilyltetramethylcyclopentadienylcycloheptylamidotitaniumAₙ; diphenylsilyltetramethylcyclopentadienylcyclooctylamidotitaniumAₙ; diphenylsilyltetramethylcyclopentadienylcyclononylamidotitaniumAₙ; diphenylsilyltetramethylcyclopentadienylcyclodecylamidotitaniumAₙ; diphenylsilyltetramethylcyclopentadienylcycloundecylamidotitaniumAₙ; diphenylsilyltetramethylcyclopentadienylcyclododecylamidotitaniumAₙ; diphenylsilyktetramethylcyclopentadienyl)(sec-butylamido)titaniumAₙ; diphenylsilyktetramethylcyclopentadienyl)(n-octylamido)titaniumAₙ; diphenylsilyktetramethylcyclopentadienyl)(n-decylamido)titaniumAₙ; and diphenylsilyktetramethylcyclopentadienyl)(n-octadecylamido)titaniumAₙ.

In one specific embodiment, the first catalyst component includes a metallocene catalyst, such as dimethylsilylbis(2-methyl-4-phenyl-indenyl)zirconium dichloride, dimethylsilylbis(2-methyl-indenyl)zirconium dichloride, dimethylsilylbis(2-methyl-4,5-benzo-indenyl)zirconium dichloride, for example. In one specific embodiment, the first catalyst component comprises dimethylsilylbis(2-methyl-4-phenyl-indenyl)zirconium dichloride, for example.

In one embodiment, the first catalyst component includes a metallocene catalyst capable of producing a polymer having a high melting point (e.g., a Tₘ of from about 135° C. to about 165° C. or from about 140° C. to about 160° C. or from 145° C. to about 155° C.).

### Second Catalyst Component

In addition to the first catalyst component, the multicomponent catalyst compositions include a “second catalyst component”.

The second catalyst component generally includes a metallocene catalyst as described above. In one specific embodiment, the second catalyst component includes a metallocene catalyst, such as dimethylsilylbis(2-methyl-4-phenyl-indenyl)zirconium dichloride, dimethylsilylbis(2-methyl-indenyl)zirconium dichloride, dimethylsilylbis(2-methyl-4,5-benzo-indenyl)zirconium dichloride, for example. In one specific embodiment, the first catalyst component comprises dimethylsilylbis(2-methyl-indenyl)zirconium dichloride, for example. However, in one specific embodiment, the second catalyst component is different from the first catalyst component.

The multicomponent catalyst system may have a ratio of first catalyst component to second catalyst component of from 1.5:1.0 or from 1.0:1.5 on a weight basis. Metallocene loading ranges from 1.0 to 2.5 wt % or from 1.5 to 2.0 wt %. The first catalyst component may be present in the multicomponent catalyst system in an amount as much as 70 wt % of the total catalyst system, or as much as 67 wt %, or as much as 60 wt %.

### Activation

In certain embodiments, the methods described herein further include contacting one or more of the catalyst components with a catalyst activator, herein simply referred to as an “activator”. The activator may include a single composition capable of activating both the first catalyst component and the second catalyst component.

For example, the metallocene catalysts may be activated with a metallocene activator for subsequent polymerization. As used herein, the term “metallocene activator” is defined to be any compound or combination of compounds, supported or unsupported, which may activate a single-site catalyst compound (e.g., metallocenes, Group 15 containing catalysts, etc.) This may involve the abstraction of at least one leaving group (A group in the formulas/structures above, for example) from the metal center of the catalyst component. The metallocene catalysts are thus activated towards olefin polymerization using such activators.

Embodiments of such activators include Lewis acids, such as cyclic or oligomeric polyhydrocarbylaluminum oxides, non-coordinating ionic activators (“NCA”), ionizing activators, stoichiometric activators, combinations thereof or any other compound that may convert a neutral metallocene catalyst component to a metallocene cation that is active with respect to olefin polymerization.

The Lewis acids may include alumoxane (e.g., “MAO”), modified alumoxane (e.g., “TIBAO”) and alkylaluminum compounds, for example. Non-limiting examples of aluminum alkyl compounds may include trimethylaluminum, triethylaluminum, triisobutylaluminum, tri-n-hexylaluminum and tri-n-octylaluminum, for example.

Ionizing activators are well known in the art and are described by, for example, Eugene You-Xian Chen & Tobin J. Marks, Cocatalysts for Metal-Catalyzed Olefin Polymerization: Activators, Activation Processes, and Structure-Activity Relationships 100(4) CHEMICAL REVIEWS 1391-1434 (2000). Examples of neutral ionizing activators include Group 13 tri-substituted compounds, in particular, tri-substituted boron, tellurium, aluminum, gallium and indium compounds and mixtures thereof (e.g., tri(n-butyl)ammonium-tetrakis(pentafluorophenyl)borate and/or trisperfluorophenyl boron metalloid precursors), for example. The substituent groups may be independently selected from alkyls, alkenyls, halogen, substituted alkyls, aryls, arylhalides, alkoxy and halides, for example. In one embodiment, the three groups are independently selected from halogens, mono or multicyclic (including halosubstituted) aryls, alkyls, alkenyl compounds and mixtures thereof, for example. In another embodiment, the three groups are selected from C₁ to C₂₀ alkenyls, C₁ to C₂₀ alkyls, C₁ to C₂₀ alkoxys, C₃ to C₂₀ aryls and combinations thereof, for example. In yet another embodiment, the three groups are selected from the group highly halogenated C₁ to C₄ alkyls, highly halogenated phenyls, and highly halogenated naphthyls and mixtures thereof, for example. By “highly halogenated”, it is meant that at least 50% of the hydrogens are replaced by a halogen group selected from fluorine, chlorine and bromine.

Illustrative, not limiting examples of ionic ionizing activators include trialkyl-substituted ammonium salts (e.g., triethylammoniumtetraphenylborate, tripropylammoniumtetraphenylborate, tri(n-butyl)ammoniumtetraphenylborate, trimethylammoniumtetra(p-tolyl)borate, trimethylammoniumtetra(o-tolyl)borate, tributylammoniumtetra(pentafluorophenyl)borate, tripropylammoniumtetra(o,p-dimethylphenyl)borate, tributylammoniumtetra(m,m-dimethylphenyl)borate, tributylammoniumtetra(p-tri-fluoromethylphenyl)borate, tributylammoniumtetra(pentafluorophenyl)borate and tri(n-butyl)ammoniumtetra(o-tolyl)borate), N,N-dialkylanilinium salts (e.g., N,N-dimethylaniliniumtetraphenylborate, N,N-diethylaniliniumtetraphenylborate and N,N-2,4,6-pentamethylaniliniumtetraphenylborate), dialkyl ammonium salts (e.g., diisopropylammoniumtetrapentafluorophenylborate and dicyclohexylammoniumtetraphenylborate), triaryl phosphonium salts (e.g., triphenylphosphoniumtetraphenylborate, trimethylphenylphosphoniumtetraphenylborate and tridimethylphenylphosphoniumtetraphenylborate) and their aluminum equivalents, for example.

In yet another embodiment, an alkylaluminum compound may be used in conjunction with a heterocyclic compound. The ring of the heterocyclic compound may include at least one nitrogen, oxygen, and/or sulfur atom, and includes at least one nitrogen atom in one embodiment. The heterocyclic compound includes 4 or more ring members in one embodiment, and 5 or more ring members in another embodiment, for example.

The heterocyclic compound for use as an activator with an alkylaluminum compound may be unsubstituted or substituted with one or a combination of substituent groups. Examples of suitable substituents include halogens, alkyls, alkenyls or alkynyl radicals, cycloalkyl radicals, aryl radicals, aryl substituted alkyl radicals, acyl radicals, aroyl radicals, alkoxy radicals, aryloxy radicals, alkylthio radicals, dialkylamino radicals, alkoxycarbonyl radicals, aryloxycarbonyl radicals, carbomoyl radicals, alkyl- or dialkyl-carbamoyl radicals, acyloxy radicals, acylamino radicals, aroylamino radicals, straight, branched or cyclic, alkylene radicals or any combination thereof, for example.

Non-limiting examples of hydrocarbon substituents include methyl, ethyl, propyl, butyl, pentyl, hexyl, cyclopentyl, cyclohexyl, benzyl, phenyl, fluoromethyl, fluoroethyl, difluoroethyl, iodopropyl, bromohexyl or chlorobenzyl, for example.

Non-limiting examples of heterocyclic compounds utilized include substituted and unsubstituted pyrroles, imidazoles, pyrazoles, pyrrolines, pyrrolidines, purines, carbazoles, indoles, phenyl indoles, 2,5-dimethylpyrroles, 3-pentafluorophenylpyrrole, 4,5,6,7-tetrafluoroindole or 3,4-difluoropyrroles, for example.

Combinations of activators are also contemplated by the invention, for example, alumoxanes and ionizing activators in combinations. Other activators include aluminum/boron complexes, perchlorates, periodates and iodates including their hydrates, lithium (2,2′-bisphenyl-ditrimethylsilicate)-4T-HF and silylium salts in combination with a non-coordinating compatible anion, for example. In addition to the compounds listed above, methods of activation, such as using radiation and electro-chemical oxidation are also contemplated as activating methods for the purposes of enhancing the activity and/or productivity of a single-site catalyst compound, for example. (See, U.S. Pat. No. 5,849,852, U.S. Pat. No. 5,859,653, U.S. Pat. No. 5,869,723 and WO 98/32775.)

The catalyst may be activated in any manner known to one skilled in the art. For example, the catalyst and activator may be combined in molar ratios of activator to catalyst of from 1000:1 to 0.1:1, or from 500:1 to 1:1, or from about 100:1 to about 250:1, or from 150:1 to 1:1, or from 50:1 to 1:1, or from 10:1 to 0.5:1 or from 3:1 to 0.3:1, for example.

### Support

The activators may or may not be associated with or bound to a support, either in association with one or more catalyst component or separate from the catalyst component(s), such as described by Gregory G. Hlalky, Heterogeneous Single-Site Catalysts for Olefin Polymerization 100(4) CHEMICAL REVIEWS 1347-1374 (2000).

For example, each different catalyst component may reside on a single support particle, so that the multicomponent catalyst is a supported multicomponent catalyst. However, as used herein, the term multicomponent catalyst also broadly includes a system or mixture in which one of the catalysts (e.g., the first catalyst component) resides on one collection of support particles and another catalyst (e.g., the second catalyst component) resides on another collection of support particles. In the latter instance, the two supported catalysts are introduced to a single reactor, either simultaneously or sequentially and polymerization is conducted in the presence of the multicomponent catalyst. In certain embodiments, an unsupported version of the multicomponent catalyst described herein can be used in a polymerization process, i.e., in which the monomers are contacted with a multicomponent catalyst that is not supported.

The support materials may include talc, inorganic oxides, clays and clay minerals, ion-exchanged layered compounds, diatomaceous earth compounds, zeolites or a resinous support material, such as a polyolefin, for example. Specific examples of silica supports include P10 (available from Fuji-Silysia). In a further embodiment, the silica is modified with MAO (methylaluminoxane).

Specific inorganic oxides include silica, alumina, magnesia, titania and zirconia, for example. The inorganic oxides used as support materials may have an average particle size of from 5 microns to 600 microns or from 10 microns to 100 microns, a surface area of from 50 m²/g to 1,000 m²/g or from 100 m²/g to 400 m²/g and a pore volume of from 0.5 cc/g to 3.5 cc/g or from 0.5 cc/g to 2 cc/g, for example.

Methods for supporting metallocene catalysts are generally known in the art. (See, U.S. Pat. No. 5,643,847, U.S. patent Ser. Nos. 09/184,358 and 09/184,389, which are incorporated by reference herein.)

Various methods can be used to affix two different metallocene components to a support to form a multicomponent catalyst (also referred to as a “mixed catalyst”). For example, one procedure for preparing a supported multicomponent catalyst can include providing a supported first catalyst component, contacting a slurry including the first catalyst component and a non-polar hydrocarbon with a mixture (solution or slurry) that includes the second catalyst component, which may also include an activator. The procedure may further include drying the resulting product that includes the first and second catalyst components and recovering a multicomponent catalyst composition. Another method may include reacting the silica (such as P10) with MAO in a hydrocarbon solvent and heat to form an MAO-modified silica. Subsequent steps then include adding the first catalyst component to the MAO-modified silica, then adding the second catalyst component to form a multicomponent catalyst on a single support. Another method may include mixing the first catalyst component and the second catalyst component in a solvent then adding the MAO-modified silica. Another method may include supporting the first catalyst component on a first MAO-modified silica and supporting the second catalyst component on a second MAO-modified silica and physically mixing the supported catalysts. Alternatively, it is contemplated that the first and second catalyst components may be independently fed to one or more reaction zones, so long as each reaction zone includes a multicomponent system as described herein.

Resin reactor blending can be achieved by either separate supported catalysts mixing inside the catalyst pot before being injected into the loop reactor (Metallocene Catalyst Mixing) or metallocene deposition on the same support during the supported catalyst preparation (Metallocene Catalyst Co-Supporting).

Optionally, the support material, one or more of the catalyst components, the catalyst system or combinations thereof, may be contacted with one or more scavenging compounds prior to or during polymerization. The term “scavenging compounds” is meant to include those compounds effective for removing impurities (e.g., polar impurities) from the subsequent polymerization reaction environment. Impurities may be inadvertently introduced with any of the polymerization reaction components, particularly with solvent, monomer and catalyst feed, and adversely affect catalyst activity and stability. Such impurities may result in decreasing, or even elimination, of catalytic activity, for example. The polar impurities or catalyst poisons may include water, oxygen and metal impurities, for example.

The scavenging compound may include an excess of the aluminum containing compounds described above, or may be additional known organometallic compounds, such as Group 13 organometallic compounds. For example, the scavenging compounds may include trimethyl aluminum (TMA), triisobutyl aluminum (TIBAl), methylalumoxane (MAO), isobutyl aluminoxane, triethylaluminum (TEAl), and tri-n-octyl aluminum. In one specific embodiment, the scavenging compound is TIBAl.

In one embodiment, the amount of scavenging compound is minimized during polymerization to that amount effective to enhance activity and avoided altogether if the feeds and polymerization medium may be sufficiently free of impurities.

### Polymerization Processes

Once the catalyst system is prepared, as described above and/or as known to one skilled in the art, a variety of processes may be carried out using that composition. The equipment, process conditions, reactants, additives and other materials used in polymerization processes will vary in a given process, depending on the desired composition and properties of the polymer being formed. Such processes may include solution phase, gas phase, slurry phase, bulk phase, high pressure processes or combinations thereof, for example. (See, U.S. Pat. No. 5,525,678; U.S. Pat. No. 6,420,580; U.S. Pat. No. 6,380,328; U.S. Pat. No. 6,359,072; U.S. Pat. No. 6,346,586; U.S. Pat. No. 6,340,730; U.S. Pat. No. 6,339,134; U.S. Pat. No. 6,300,436; U.S. Pat. No. 6,274,684; U.S. Pat. No. 6,271,323; U.S. Pat. No. 6,248,845; U.S. Pat. No. 6,245,868; U.S. Pat. No. 6,245,705; U.S. Pat. No. 6,242,545; U.S. Pat. No. 6,211,105; U.S. Pat. No. 6,207,606; U.S. Pat. No. 6,180,735 and U.S. Pat. No. 6,147,173, which are incorporated by reference herein.)

In certain embodiments, the processes described above generally include polymerizing one or more olefin monomers to form polymers. The olefin monomers may include C₂ to C₃₀ olefin monomers, or C₂ to C₁₂ olefin monomers (e.g., ethylene, propylene, butene, pentene, methylpentene, hexene, octene and decene), for example. Other monomers include ethylenically unsaturated monomers, C₄ to C₁₈ diolefins, conjugated or nonconjugated dienes, polyenes, vinyl monomers and cyclic olefins, for example. Non-limiting examples of other monomers may include norbornene, nobornadiene, isobutylene, isoprene, vinylbenzocyclobutane, sytrene, alkyl substituted styrene, ethylidene norbornene, dicyclopentadiene and cyclopentene, for example. The formed polymer may include homopolymers, copolymers or terpolymers, for example.

Examples of solution processes are described in U.S. Pat. No. 4,271,060, U.S. Pat. No. 5,001,205, U.S. Pat. No. 5,236,998 and U.S. Pat. No. 5,589,555, which are incorporated by reference herein.

One example of a gas phase polymerization process includes a continuous cycle system, wherein a cycling gas stream (otherwise known as a recycle stream or fluidizing medium) is heated in a reactor by heat of polymerization. The heat is removed from the cycling gas stream in another part of the cycle by a cooling system external to the reactor. The cycling gas stream containing one or more monomers may be continuously cycled through a fluidized bed in the presence of a catalyst under reactive conditions. The cycling gas stream is generally withdrawn from the fluidized bed and recycled back into the reactor. Simultaneously, polymer product may be withdrawn from the reactor and fresh monomer may be added to replace the polymerized monomer. The reactor pressure in a gas phase process may vary from about 100 psig to about 500 psig, or from about 200 psig to about 400 psig or from about 250 psig to about 350 psig, for example. The reactor temperature in a gas phase process may vary from about 30° C. to about 120° C., or from about 60° C. to about 115° C., or from about 70° C. to about 110° C. or from about 70° C. to about 95° C., for example. (See, for example, U.S. Pat. No. 4,543,399; U.S. Pat. No. 4,588,790; U.S. Pat. No. 5,028,670; U.S. Pat. No. 5,317,036; U.S. Pat. No. 5,352,749; U.S. Pat. No. 5,405,922; U.S. Pat. No. 5,436,304; U.S. Pat. No. 5,456,471; U.S. Pat. No. 5,462,999; U.S. Pat. No. 5,616,661; U.S. Pat. No. 5,627,242; U.S. Pat. No. 5,665,818; U.S. Pat. No. 5,677,375 and U.S. Pat. No. 5,668,228, which are incorporated by reference herein.)

Slurry phase processes generally include forming a suspension of solid, particulate polymer in a liquid polymerization medium, to which monomers and optionally hydrogen, along with catalyst, are added. The suspension (which may include diluents) may be intermittently or continuously removed from the reactor where the volatile components can be separated from the polymer and recycled, optionally after a distillation, to the reactor. The liquefied diluent employed in the polymerization medium may include a C₃ to C₇ alkane (e.g., hexane or isobutane), for example. The medium employed is generally liquid under the conditions of polymerization and relatively inert. A bulk phase process is similar to that of a slurry process with the exception that the liquid medium is also the reactant (e.g., monomer) in a bulk phase process. However, a process may be a bulk process, a slurry process or a bulk slurry process, for example.

In a specific embodiment, a slurry process or a bulk process may be carried out continuously in one or more loop reactors. The catalyst, as slurry or as a dry free flowing powder, may be injected regularly to the reactor loop, which can itself be filled with circulating slurry of growing polymer particles in a diluent, for example. Optionally, hydrogen may be added to the process, such as for molecular weight control of the resultant polymer. The loop reactor may be maintained at a pressure of from about 27 bar to about 50 bar or from about 35 bar to about 45 bar and a temperature of from about 38° C. to about 121° C., for example. Reaction heat may be removed through the loop wall via any method known to one skilled in the art, such as via a double jacketed pipe or heat exchanger, for example.

Alternatively, other types of polymerization processes may be used, such as stirred reactors in series, parallel or combinations thereof, for example. Upon removal from the reactor, the polymer may be passed to a polymer recovery system for further processing, such as addition of additives and/or extrusion, for example.

Further, a two-staged sequential polymerization process wherein a miPP/sPP/EPR (ethylene-propylene rubber) reactor blend can be obtained.

### Catalyst Activity

In one embodiment, the multicomponent catalyst has an activity of from 5 kg/g/hr to 25 kg/g/hr, or from 7 kg/g/hr to 17 kg/g/hr, or from 9 kg/g/hr to 15 kg/g/hr, or from 11 kg/g/hr to 13 kg/g/hr.

In one embodiment, the multicomponent catalyst has a conversion of propylene of from 15 to 60%, or from 20 to 50%, or from 25 to 45%.

### Polymer Product

The polymers (and blends thereof) formed via the processes described herein may include, but are not limited to, polypropylene (e.g., syndiotactic, atactic and isotactic) and polypropylene copolymers, for example.

The polymers can have a variety of compositions, characteristics and properties. At least one of the advantages of the multicomponent catalysts is that the process utilized can be tailored to form a polymer composition having a desired set of properties. A non-limiting discussion of such properties follows.

In one embodiment, the polymers include propylene polymers. In one embodiment, the propylene polymer includes isotactic polypropylene.

The propylene polymers may include propylene homopolymers or copolymers. Unless otherwise specified, the terms “propylene polymer” or “polypropylene” may refer to propylene homopolymers or those polymers composed primarily of propylene and limited amounts of other comonomers, such as ethylene, wherein the comonomer makes up less than 0.5 wt. % or less than about 0.1 wt. % by weight of polymer, or to propylene copolymers composed primarily of propylene and a comonomer, such as ethylene, wherein the comonomer makes up from 1 wt % to 20 wt %, or from 3 wt % to 15 wt % of the polymer.

The propylene polymer may include ethylene-propylene rubber (EPR). Such a composition would be formed via a two-staged sequential polymerization process, well known to those of ordinary skill in the art.

In one embodiment, the propylene polymer exhibits a melt flow rate of from 1 to greater than 200 g/10 min., or from 10 to 150 g/10 min., or from 20 to 100 g/10 min., or from 30 to 80 g/10 min., or from 40 to 65 g/10 min. The melt flow rate may also be from 0.02 to 10 g/10 min. or from 2 g/10 min. to 5 g/10 min.

In one embodiment, the propylene polymer exhibits a melting point of from 120 to 160° C., or from 150 to 155° C., or from 140 to 145° C.

In one embodiment, the propylene polymer exhibits a xylene solubles level from 0.20 to 10.00 wt %, or from 0.25 to 1.20 wt %, or from 0.35 to 0.80 wt %, or from 0.40 to 0.65 wt %, or from 0.45 to 0.60 wt %.

### Product Application

The polymers and blends thereof are useful in applications known to one skilled in the art, such as forming operations (e.g., film, sheet, pipe and fiber extrusion and co-extrusion as well as blow molding, injection molding and rotary molding). Films include blown or cast films formed by co-extrusion or by lamination useful as shrink film, cling film, stretch film, sealing films, oriented films, snack packaging, heavy duty bags, grocery sacks, baked and frozen food packaging, medical packaging, industrial liners, and membranes, for example, in food-contact and non-food contact application. Fibers include melt spinning, solution spinning and melt blown fiber operations for use in woven or non-woven form to make filters, diaper fabrics, medical garments and geotextiles, for example. Extruded articles include medical tubing, wire and cable coatings, geomembranes and pond liners, for example. Molded articles include single and multi-layered constructions in the form of bottles, tanks, large hollow articles, rigid food containers and toys, for example.

### EXAMPLES

As used in the examples, metallocene type “m” refers to rac-dimethylsilanylbis(2-methyl-4-phenyl-1-indenyl)zirconium dichloride.

As used in the examples, metallocene type “n” refers to rac-dimethylsilanylbis(2-methyl-1-indenyl)zirconium dichloride.

Unless otherwise designated herein, all testing methods are the current methods at the time of filing.

The m and n catalysts were first prepared separately with 1.0 wt % metallocene deposition/cationization in toluene using a P-10 silica/MAO support prepared by reaction of MAO with silica in toluene at 115° C. for 4 hours. The mineral oil suspended catalysts were then mixed with different weight ratio under nitrogen at room temperature. This catalyst blend is referred to in the Figures and Tables as ‘m’+‘n’ as the catalyst components are individually supported and then blended.

The two metallocenes, m and n, were mixed together in toluene and then deposited on the MAO-modified silica carrier P10 (P10/MAO (1.0/0.7 in wt)) prepared via reaction of MAO with silica in toluene at 115° C. for 4 hours. This catalyst blend is referred to in the Figures and Tables as ‘m+n’ as both catalyst components are supported on a single support.

The polymerization conditions were 20 mg supported catalyst, ca. 720 g. propylene, 40 mg TEAL as scavenger in 2 L Autoclave Zipper reactor with initial hydrogen concentration varied (depending on reaction conditions as listed in the Tables or in the Figures), at 70° C. for 1 hour.

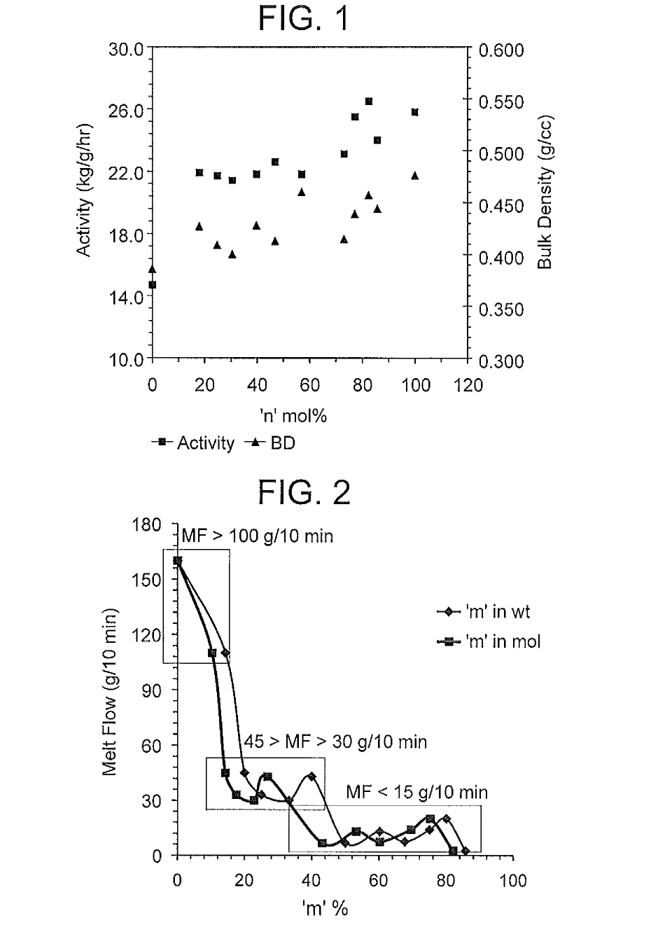

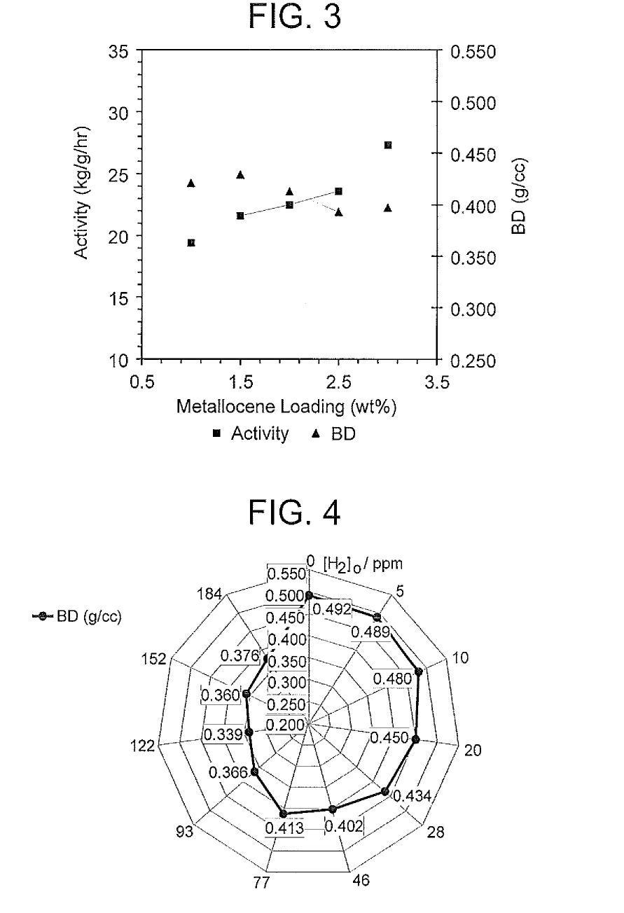

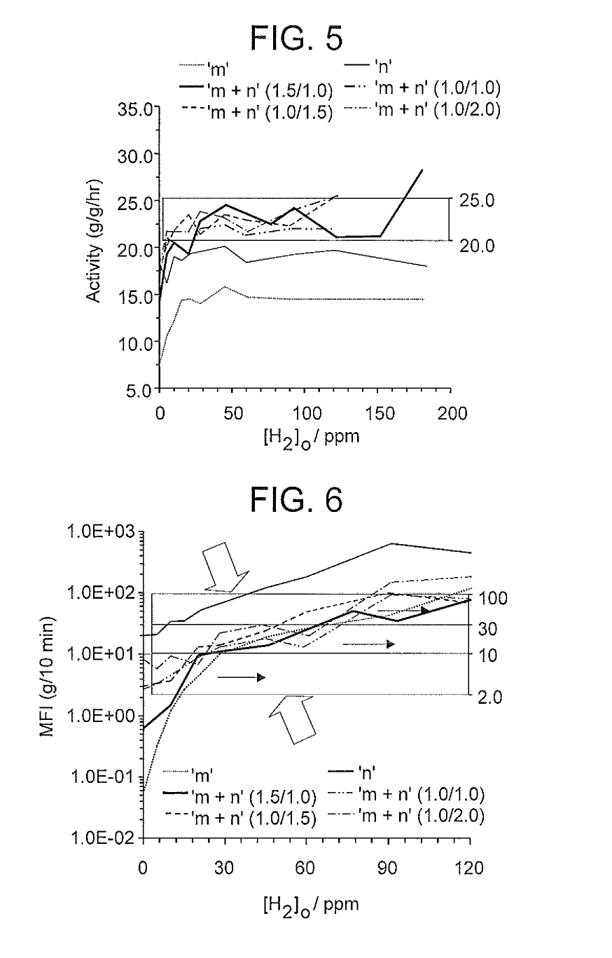

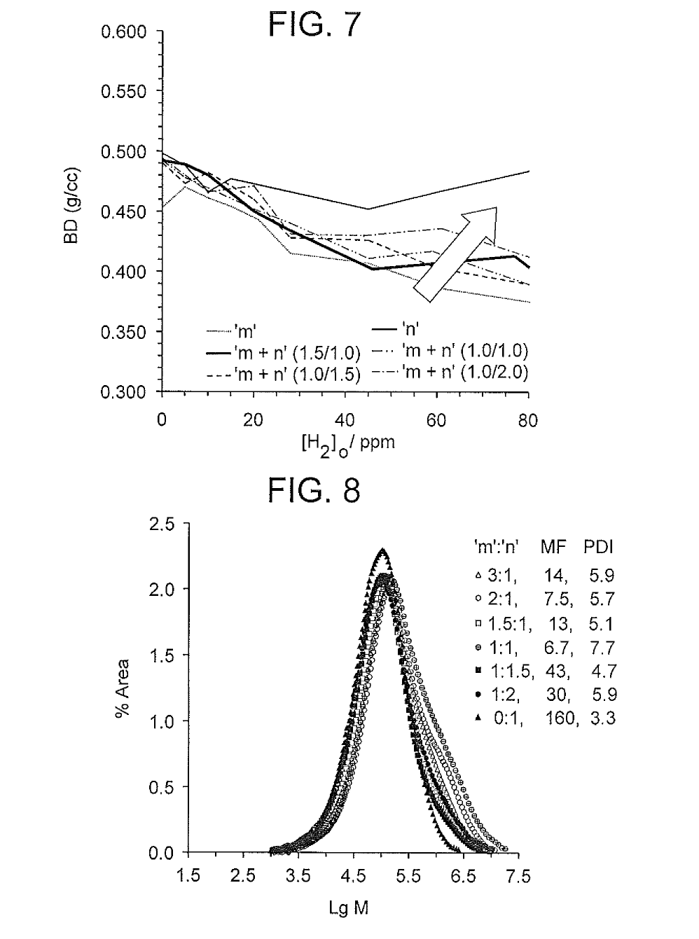

FIGS. 1-7 show ‘m+n’ catalysts. As can be seen in FIG. 1, the catalyst activity increased from 14 to between 22 and 26 kg/g/hr, and the fluff bulk density increased from 0.40 to 0.44 g/cc with an increase in the amount of n used. As shown in FIG. 2, controlling the content of m catalyst results in control of the resins melt flow. FIG. 3 and Table 1 show that a 2.0 wt % catalyst loading is a good compromise based on economics. FIG. 4 and Table 2 show that the m catalyst is sensitive to hydrogen concentration. FIG. 5 demonstrates the synergy for catalyst activity from the mixing catalyst because the mixed catalyst renders higher activity than either single metallocene under a broad range of hydrogen concentration. FIG. 6 shows that the fluff melt flows are similar to the m catalyst fluff melt flows. FIG. 7 shows that fluff bulk density improves under different hydrogen conditions.

TABLE 1
Propylene Polymerization with ‘m + n’
Mixed Catalysts on MAO-Modified Support Prepared
from P10 Silica Carrier under Different Metallocene Loading ^{a)}

| | ‘m + n’ | | Propylene | | | MF |
|---|---|---|---|---|---|---|
| | Loading | Polymer | Conversion | Activity | BD | (g/10 |
| Entry | in wt % ^{b)} | Yield (g) | (%) | (kg/g/hr) | (g/cc) | min) |
| 1 | 1.0 | 387 | 54 | 19.4 | 0.421 | 10 |
| 2 | 1.5 | 437 | 60 | 21.6 | 0.429 | 10 |
| 3 ^{c)} | 2.0 | 458 | 63 | 22.5 | 0.413 | 14 |
| 4 ^{c)} | 2.5 | 455 | 63 | 23.6 | 0.393 | 26 |
| 5 ^{d)} | 2.5 | 259 | 36 | 25.4 | 0.373 | 155 |
| 6 ^{c)} | 3.0 | 464 | 64 | 27.3 | 0.397 | 19 |
| 7 ^{d)} | 3.0 | 259 | 36 | 25.9 | 0.384 | 182 |

^{a)} ‘m’ and ‘n’ metallocenes were mixed in toluene and then deposited/cationized on the MAO-modified P10 silica Polymerization conditions: 20 mg supported catalyst, ca. 720 g propylene, 40 mg TEAL as scavenger in 2 L Autoclave Zipper reactor with initial hydrogen concentration 60 ppm, 70° C. for 1 hour.
^{b)} The ‘m’:‘n’ weight ratio is 1.5:1 with different total metallocene loading.
^{c)} Propylene conversion is too high, and the stir slowed down at the later stage of the polymerization (~50 min).
^{d)} Ten mg catalysts were used with the other conditions being identical as ^{a)}.

TABLE 2
Polymerization under Different Initial Hydrogen Concentration with ‘m’
and ‘n’ on MAO-Modified Support Prepared from P10 Silica Carrier ^{a)}

| | | | Propylene | | | | Melting Point | | | | |
|---|---|---|---|---|---|---|---|---|---|---|---|
| | [H₂]ₒ | Polymer | Conversion | Activity | BD | MF | (° C.) ^{c)} | | Xsol | Mn | |
| Entry | (ppm) ^{b)} | Yield (g) | (%) | (kg/g/hr) | (g/cc) | (g/10 min) | 1^{st} | 2^{nd} | (wt %) | (×10⁻³) | PDI |
| 1 | 0 | 353 | 49 | 17.6 | 0.490 | 3^{.0} | 146.7 | — | 0.04 | 106.6 | 4.7 |
| 2 | 5 | 403 | 55 | 20.2 | 0.473 | 3^{.4} | 147.4 | — | 0.12 | 108.3 | 3.5 |
| 3 | 10 | 443 | 57 | 21.8 | 0.482 | 3^{.7} | 147.4 | 152.7 | 0.04 | 103.0 | 3.6 |
| 5 | 20 | 469 | 65 | 23.5 | 0.460 | 13 | 147.4 | 152.9 | 0.20 | 74.8 | 3.9 |
| 6 | 28 | 426 | 59 | 21.4 | 0.428 | 14 | 147.0 | 152.9 | 0.12 | 66.0 | 4.0 |
| 7 | 44 | 462 | 62 | 23.3 | 0.441 | 14 | 148.3 | — | 0.12 | 56.5 | 4.8 |
| 7b ^{c)} | 45 | 453 | 62 | 23.5 | 0.426 | 24 | 147.0 | 153.1 | 0.36 | 46.0 | 4.7 |
| 8 ^{c)} | 60 | 451 | 62 | 22.9 | 0.403 | 49 | 149.7 | — | 0.16 | 37.9 | 5.0 |
| 9 | 90 | 447 | 61 | 22.3 | 0.383 | 100 | 148.3 | 154.3 | 0.20 | 31.7 | 4.8 |
| 10 ^{c)} | 120 | 459 | 63 | 24.0 | 0.423 | 30 | 148.7 | 154.6 | 0.28 | 38.0 | 5.9 |
| 10b ^{c)} | 122 | 422 | 59 | 25.3 | 0.386 | 69 | 147.4 | 152.4 | 0.6 | 32.1 | 5.5 |

^{a)} Toluene used for deposition/cationization of ‘m’ and ‘n’ @ 1.0/1.5 in wt with total metallocene loading 2.0 wt % on the MAO-modified support. Polymerization conditions: 20 mg supported catalyst, ca. 720 g propylene, 40 mg TEAL as scavenger in 2 L Autoclave Zipper reactor at 70° C. for 1 hr.
^{b)} [Hydrogen]ₒ is the concentration before the catalyst was charged into the reactor.
^{c)} The polymerization time is less than expected 60 min due to the slow-down of the stirring rate (500 rpm). They were 58, 59, 58 and 50 min, respectively, as in the entry order.

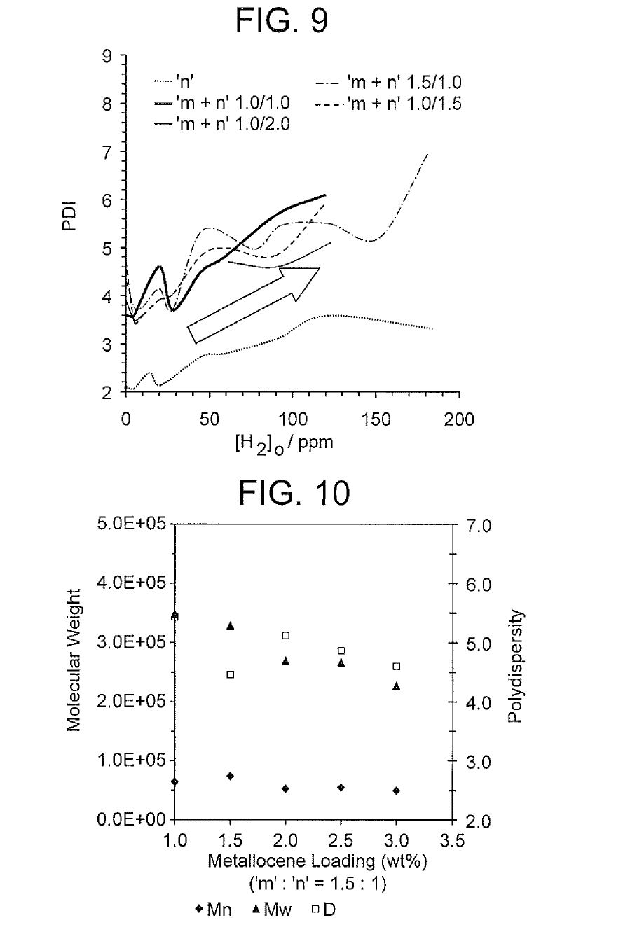

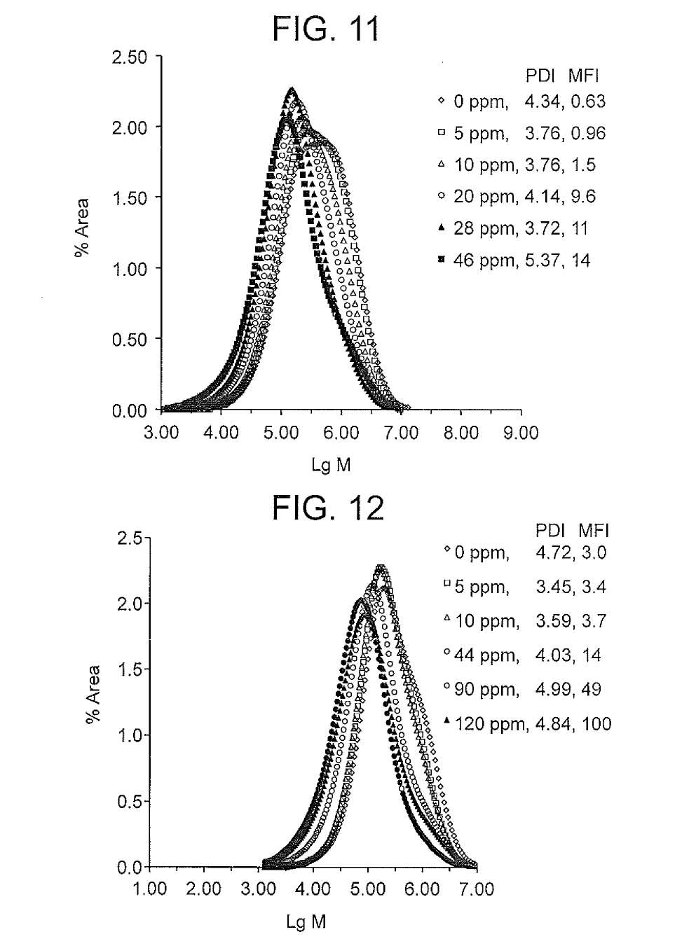

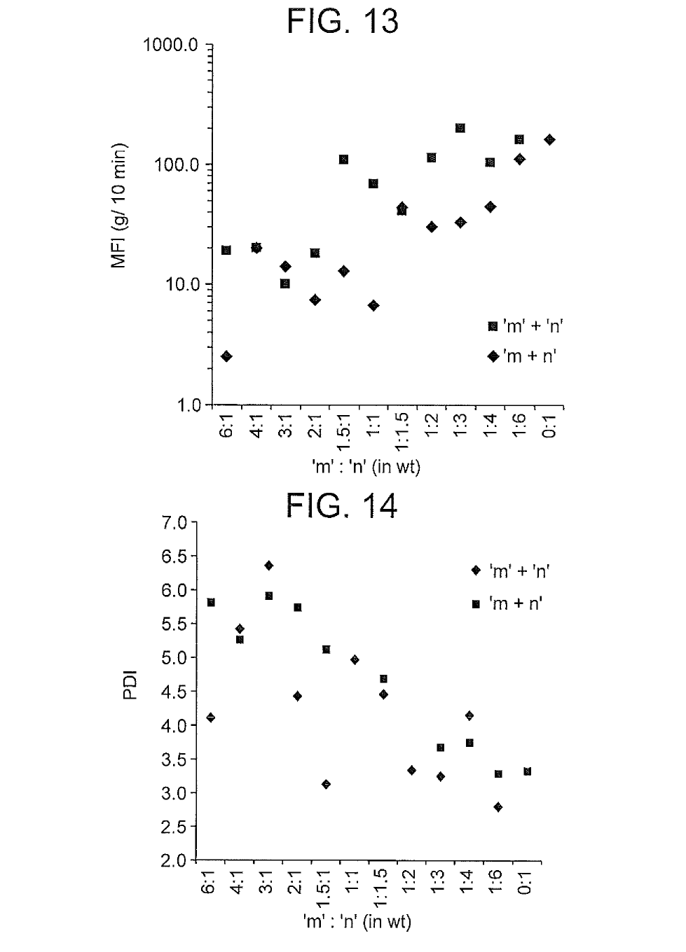

FIGS. 8-12 show ‘m+n’ catalysts, and FIGS. 13-14 show both ‘m+n’ and ‘m’+‘n’ catalyst blends. The appropriate mixing of ‘m’ and ‘n’ resulted in broadening the molecular weight distribution (MWD) of miPP with little impact on the fluff melting points and xylene solubles, as shown in Table 3 and FIG. 8. FIG. 9 shows that the MWDs are broader for the mixed catalyst than for the single component catalysts. FIGS. 10 and 11 show the low melt resin production, and FIG. 12 shows the production of higher melt flow resins. FIGS. 13 and 14 demonstrate the differences in resulting melt flow and MWD for ‘m+n’ vs. ‘m’+‘n’.

TABLE 3
Propylene Polymerization with ‘m + n’
Mixed Catalysts on MAO-Modified Support Prepared
from P10 Silica Carrier under Different Weight Ratio ^{a)}

| | ‘m’:‘n’ | | | | | |
|---|---|---|---|---|---|---|
| | (in metal- | Activity | Melt Point | Mn | | Xsol |
| Entry | locene wt) ^{b)} | (kg/g/hr) | (° C.) | (×10³) | PDI | (wt %) |
| 1 | 6:1 | 21.9 | 138.0, 151.5, | 81.7 | 5.8 | 0.08 |
| | | | 154.6 | | | |
| 2 | 4:1 | 021.7 | 149.0, 153.4 | 58.1 | 5.3 | 0.28 |
| 3 | 3:1 | 21.4 | 149.0, 153.3 | 53.4 | 5.9 | 0.08 |
| 4 | 2:1 | 21.8 | 148.7, 153.4 | 72.8 | 5.7 | 0.20 |
| 5 | 1.5:1 | 22.6 | 149.0, 153.8 | 52.6 | 5.1 | 0.16 |
| 6 | 1:1 | 21.8 | 146.7, 152.0 | 62.5 | 7.7 | 0.36 |
| 7 | 1:1.5 | 23.1 | 148.4, 153.6 | 45.9 | 4.7 | 0.20 |
| 8 ^{c)} | 1:2 | 25.5 | 145.4, 151.1 | 41.2 | 5.9 | 0.40 |
| 9 ^{c)} | 1:3 | 26.5 | 146.0, 152.0 | 54.9 | 3.7 | 0.16 |
| 10 ^{c)} | 1:4 | 24.0 | 146.4, 152.0 | 48.8 | 3.8 | 0.04 |
| 11 ^{c)} | 1:6 | 19.6 | 146.7, 152.6 | 37.5 | 3.3 | 0.12 |
| 12 ^{c)} | 0:1 | 25.8 | 144.7, 150.0 | 42.5 | 3.3 | 0.24 |

^{a)} ‘m’ and ‘n’ metallocenes were mixed in toluene and then deposited/cationized on the MAO-modified P10 silica carrier. Polymerization conditions: 20 mg supported catalyst, ca. 720 g propylene, 40 mg TEAL as scavenger in 2 L Autoclave Zipper reactor with initial hydrogen concentration 60 ppm, 70° C. for 1 hour.
^{b)} The total metallocene loading of the final ‘m + n’ mixed catalysts is 2.0 wt %. The percentage of each metallocene was determined by weight.
^{c)} Propylene conversion is too high, and the stir slowed down at the later stage of the polymerization (~50 min).

For the production of mRCP resins the catalyst used comprised of a 2% metallocene loading on 0.7/1 MAO on P10 silica. The metallocene component was a 1.5:1 wt % ratio of m and n. The observation of high solubles with moderate levels (1 and 2%) of ethylene in the feed illustrated a key feature of the m+n catalyst and that is that the ethylene response of the m and n metallocenes are different. Table 4 provided the screening results of m+n catalyst for mRCP.

TABLE 4
Initial Screening Results on M + N Catalyst for Random Copolymers

| Notebook | [Cocat] | % C2 | FTIR C2 | Activity | MFI | | Mw/Mn | | | |
|---|---|---|---|---|---|---|---|---|---|---|
| # | ppm | Feed | Content | (g/g/h) | (g/10 min) | Mw | (D) | XS % | Tm (C.) | dHf (J/g) |
| 1054-136 | 62 | 0 | 0 | 30000 | 54 | 129056 | 3.2 | 0.48 | 149 | 90.708 |
| 1054-137 | 44 | 0.75 | 3.3 | 19800 | 626 | 64168 | 3.2 | 3.8 | 146 | 47.092 |
| 1054-138 | 44 | 1.5 | 6.8 | 16800 | 195 | 96195 | 3.3 | 35 | 142 | 38.44 |

Polymerization Conditions: 4 Liter bench reactor in lab 185 was used with 1.3 Kg of Propylene, 15 ppm Catalyst, 36 ppm Hydrogen, at 55° C. for 15 minutes.

To explore the nature of the M+N catalyst further required consideration of the copolymerization behavior of the N metallocene catalyst on its own. The catalyst used consisted of 2% n on 0.7/1 MAO on P10 and polymerizations were conducted with a shortened polymerization time of 30 min and ethylene/hydrogen were batched in to the reactor at the start of the run. Results are summarized in Table 5. The ethylene incorporation rate of the N catalyst was much higher than that of the M catalyst with the copolymer formed being enriched in ethylene compared to the feed composition. The copolymer produced with 1% ethylene in the feed had 8.4% ethylene in the copolymer. By contrast, the m catalyst usually incorporates about 1% ethylene for every 1% in the feed under these conditions. The decrease in the melting temperature of the resulting copolymer also reflected the high level of ethylene incorporation. Typically, 1 wt % ethylene in copolymers reduces the melting temperature about 5-6° C. Molecular weight distribution was not sensitive to ethylene concentration (all were narrow) but this is typically not the case for multi-site catalysts. The xylene soluble fraction was low for the homopolymer and as expected increased dramatically as the melting temperature of the resin approached 110° C. Polypropylene resins with low melting temperature (<110° C.), low crystallinity level (<15%) and slow crystallization rates are by their nature, soluble in xylene.

TABLE 5
Ethylene Response of N Catalyst

| | [H₂] | [E] wt % | Tₘ | ΔH | | | |
|---|---|---|---|---|---|---|---|
| Run | ppm | in Feed | (C.) | (J/g) | M_{w} | M_{w}/Mₙ | Xsols |
| 1 | 0 | 0 | 148.4 | 83 | 231,400 | 2.1 | 0.2 |
| 2 | 0 | 1 | 105 | 26 | 67,100 | 1.9 | 49 |
| 3 | 36 | 0 | 152.9 | 83 | 91,100 | 2.4 | 0.1 |
| 4 | 36 | 0.5 | 114 | 46 | 62,000 | 2.1 | 7.3 |
| 5 | 36 | 1 | 105 | 20 | 59,000 | 2.0 | 79 |

Polymerization Conditions: 4 L rx, 1.3 kg C3, 15 mg 1064-016, 90 mg TEAL, 60° C., 30 min.

The behavior of the M+N catalyst towards ethylene-propylene copolymerization is summarized in Table 6. The first runs conducted (1-3) without hydrogen illustrated the effect of ethylene on resin MF over a broad composition range. As seen with other metallocene catalysts, MF of the copolymer increases with increasing ethylene concentration. Polymer melting temperature decreased somewhat with ethylene content (runs 4-12) but not as much as the decrease in the heat of fusion and crystallinity of the copolymer. As shown above, 1 wt % ethylene in the feed for the N catalyst is sufficient to produce polymer with Tₘ<110° C. consequently, the xylene solubles level of the M+N catalyst remained low until such ethylene levels in the feed were reached.

TABLE 6
Ethylene Response M + N Catalyst

| | [H₂] | [E] wt % | | | ΔH | | | |
|---|---|---|---|---|---|---|---|---|
| Run | ppm | in Feed | MF | Tₘ (C.) | (J/g) | M_{w} | M_{w}/Mₙ | Xsols |
| 1 | 0 | 0 | 1.0 | 148 | 87 | 1,227,600 | 4.6 | 0.4 |
| 2 | 0 | 1 | 2.1 | 138 | 47 | 414,900 | 5.8 | 7.3 |
| 3 | 0 | 2 | 6.0 | 132.7 | 51 | 323,300 | 4.9 | 27.5 |
| 4 | 18 | 0 | 11.6 | 147.7 | 93 | 203,000 | 3.5 | 0.6 |
| 5 | 18 | 0.1 | 4.8 | 146.4 | 89 | 274,000 | 4.0 | 0.3 |
| 6 | 18 | 0.2 | 5.9 | 145.4/151 | 88 | 260,000 | 3.6 | 0.4 |
| 7 | 18 | 0.3 | 8.0 | 145/151 | 90 | 243,000 | 3.7 | 0.4 |
| 8 | 18 | 0.4 | 14.0 | 143/150 | 84 | 230,000 | 3.8 | 0.4 |
| 9 | 18 | 0.5 | 11.5 | 142.7/149.6 | 83 | 219,000 | 3.9 | 0.4 |
| 10 | 18 | 0.7 | 14.6 | 140/147 | 68 | 208,000 | 4.7 | 0.8 |
| 11 | 18 | 0.9 | 67 | 138/145 | 66 | 142,000 | 4.7 | 1.8 |
| 12 | 18 | 1 | 27 | 143.4 | 55 | 181,200 | 4.5 | 21.6 |

Polymerization Conditions: 4 L rx, 1.3 kg C3, 20 mg 1064-023, 90 mg TEAL, 18 ppm H₂, 60° C., 30 min.

In order to put the copolymerization and resin characteristics into perspective, a comparison of the copolymerization ability of other metallocenes such as the N, M, AR35 and the M+N catalysts was made.

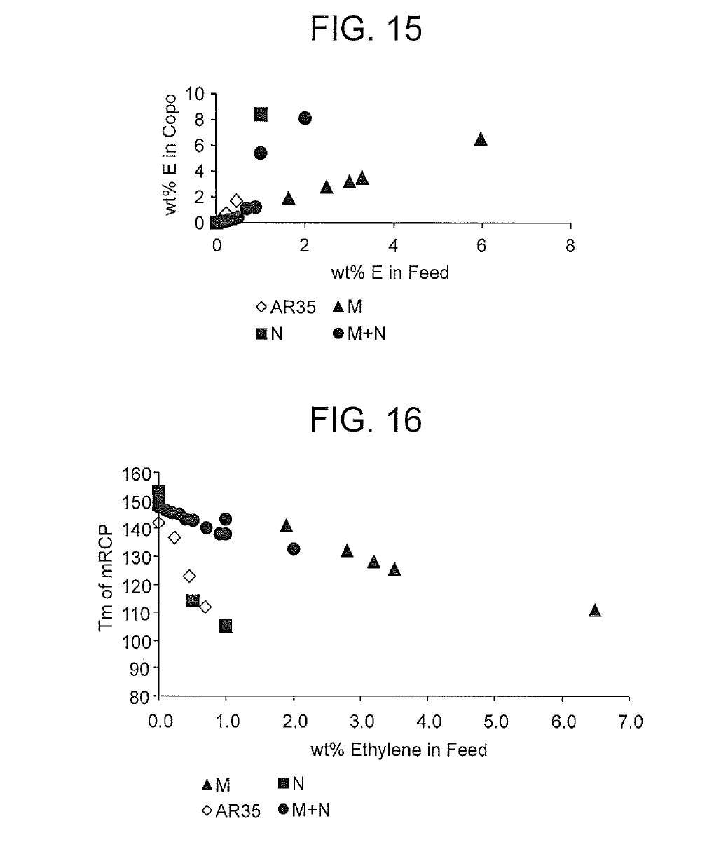

The difference in the behavior of metallocene catalysts towards E-P copolymerization can be readily gleaned by considering the relationship between wt % ethylene in the feed and wt % ethylene in the copolymer as shown in FIG. 15. Given the differences in the copolymerization behavior of the M and N metallocenes it is expected that the majority of the ethylene in the M+N copolymer is consumed by the N metallocene. The copolymerization behavior of the N metallocene is clearly more similar to that of AR35 (and other CpFlu-type metallocenes) than the M catalyst. Some difference in the reactivity ratios and/or melting temperature of the component homopolymers is a requirement for the production of broad composition random copolymers.

As mentioned above, addition of ethylene to the N catalyst reduces the molecular weight of the polymer similar to what is observed with AR35 and the ‘m’ catalyst. Remarkably, the N catalyst incorporates ethylene much more readily than the ‘m’ catalyst and very similar to what is seen with AR35 and CpFlu-type metallocenes (FIG. 16). As seen with the ‘m’ catalyst as well as copolymers produced by AR35, once the melting temperature of the copolymer approaches 110° C., the amount of polymer soluble in xylene increases substantially (FIG. 18).

The difference in copolymerization behavior of the M+N catalyst is further illustrated by considering the melting temperature of the copolymer produced as a function of ethylene wt % in the feed. As seen in FIG. 16, similar to AR35, the N catalyst in the presence of 1 wt % ethylene in the feed produces a melting temperature of 105° C. with an ethylene level (measured by IR) of 8.4 wt %. Under comparable conditions, the ‘m’ catalyst produces a melting temperature of about 145° C. As one would expect, the M+N catalyst produces mRCP with a melting temperature that closely resembles that of the ‘m’ catalyst since this is the dominant crystalline phase in the polymer.

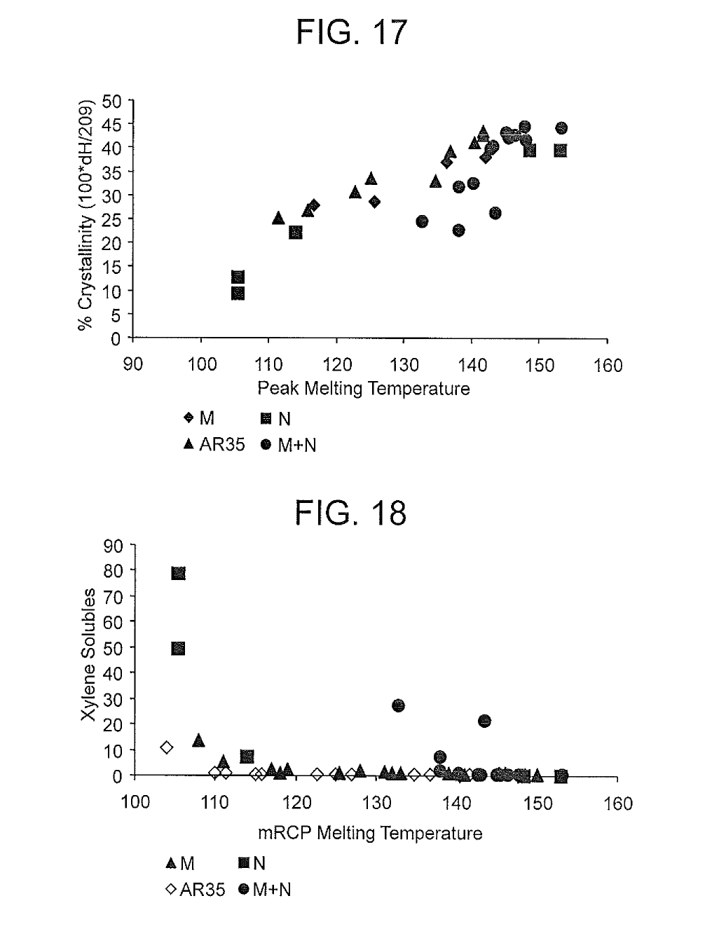

The fraction of polymer produced by the ‘N’ portion should be substantially less crystalline than that produced by the ‘M’ portion and consequently, one would expect a deviation from the standard Tₘ vs crystallinity plot for mRCP produced in the lab with M+N compared to compositionally pure materials (similar to what is observed with ICP materials). A plot of Tₘ vs crystallinity indeed shows substantial deviation (FIG. 17) from the typical relationship observed for compositionally pure materials. MRCP produced with the M+N catalyst has lower crystallinity at a given Tₘ than other materials.

In addition, the relationship between mRCP melting temperature and xylene solubles level for compositionally pure materials exhibits a flat response until the Tₘ approaches 110° C. and then increases dramatically. At such low crystallinity values the polymer is effectively soluble in xylene and the solubility is enhanced for lower molecular weight materials as seen in Table 7. The increase in xylene solubles when the melting temperature of the mRCP is between 110 and 100° C. appears to be independent of the metallocene type and represents a barrier to production of such low melting materials in a loop reactor. High solubles in loop reactors translate to sticky fluff and poor transfer properties in the reactor and the finishing sections. Clearly however, when one considers the effect of melting temperature on xylene solubles, it is evident that the M+N catalyst is producing mRCP that is compositionally different than other materials produced with single-site catalysts.

While various embodiments have been shown and described, modifications thereof can be made by one skilled in the art without departing from the spirit and teachings of the disclosure. The embodiments described herein are exemplary only, and are not intended to be limiting. Many variations and modifications of the embodiments disclosed herein are possible and are within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, etc.

Accordingly, the scope of protection is not limited by the description set out above but is only limited by the claims which follow, that scope including all equivalents of the subject matter of the claims. Each and every claim is incorporated into the specification as an embodiment of the present disclosure. Thus, the claims are a further description and are an addition to the embodiments disclosed herein. The discussion of a reference herein is not an admission that it is prior art to the present disclosure, especially any reference that may have a publication date after the priority date of this application. The disclosures of all patents, patent applications, and publications cited herein are hereby incorporated by reference, to the extent that they provide exemplary, procedural or other details supplementary to those set forth herein.

What is claimed is:

1. A polymerization process comprising:
providing a multicomponent catalyst system comprising:
a first catalyst component comprising a metallocene catalyst represented by the general formula XCp^{A}Cp^{B}MAₙ, wherein X is a structural bridge, Cp^{A} and Cp^{B} each denote a cyclopentadienyl group or derivatives thereof, each being the same or different and which may be either substituted or unsubstituted, M is a transition metal and A is an alkyl, hydrocarbyl or halogen group and n is an integer between 0 and 4; and
a second catalyst component generally represented by the formula XCp^{A}Cp^{B}MAₙ, wherein X is a structural bridge, Cp^{A} and Cp^{B} each denote a cyclopentadienyl group or derivatives thereof, each being the same or different and which may be either substituted or unsubstituted, M is a transition metal and A is an alkyl, hydrocarbyl or halogen group and n is an integer between 0 and 4;
wherein the second catalyst component is different from the first catalyst component;
introducing the multicomponent catalyst system to a reaction zone;
introducing monomer to the reaction zone;
contacting the multicomponent catalyst system with the monomer; and
withdrawing the polymer from the reaction zone.

2. The process of claim 1, wherein the first catalyst component is selected from dimethylsilylbis(2-methyl-4-phenyl-indenyl)zirconium dichloride, dimethylsilylbis(2-methyl-indenyl)zirconium dichloride, dimethylsilylbis(2-methyl-4,5-benzo-indenyl)zirconium dichloride, and combinations thereof.

3. The process of claim 1, wherein the second catalyst component is selected from dimethylsilylbis(2-methyl-4-phenyl-indenyl)zirconium dichloride, dimethylsilylbis(2-methyl-indenyl)zirconium dichloride, dimethylsilylbis(2-methyl-4,5-benzo-indenyl)zirconium dichloride, and combinations thereof.

4. The process of claim 3, wherein the first catalyst component comprises less than 70 wt % of the multicomponent catalyst.

5. The process of claim 1 wherein the activity is greater than 15 kg/g/hr.

6. The process of claim 1 wherein the monomer is propylene.

7. The process of claim 6 wherein the polymer is polypropylene.

8. The process of claim 1 wherein a second monomer is introduced into the reaction zone.

9. The process of claim 8 wherein the second monomer is ethylene.

10. The process of claim 9 wherein the polymer is a random copolymer of propylene and ethylene.

11. A bicomponent catalyst system comprising:
a first catalyst component comprising a metallocene catalyst represented by the general formula XCp^{A}Cp^{B}MAₙ, wherein X is a structural bridge, Cp^{A} and Cp^{B} each denote a cyclopentadienyl group or derivatives thereof, each being the same or different and which may be either substituted or unsubstituted, M is a transition metal and A is an alkyl, hydrocarbyl or halogen group and n is an integer between 0 and 4; and
a second catalyst component generally represented by the formula XCp^{A}Cp^{B}MAₙ, wherein X is a structural bridge, Cp^{A} and Cp^{B} each denote a cyclopentadienyl group or derivatives thereof, each being the same or different and which may be either substituted or unsubstituted, M is a transition metal and A is an alkyl, hydrocarbyl or halogen group and n is an integer between 0 and 4;
wherein the second catalyst is different from the first catalyst.

12. The catalyst system of claim 11, wherein the second catalyst component is selected from dimethylsilylbis(2-methyl-4-phenyl-indenyl)zirconium dichloride, dimethylsilylbis(2-methyl-indenyl)zirconium dichloride, dimethylsilylbis(2-methyl-4,5-benzo-indenyl)zirconium dichloride and combinations thereof.

13. The catalyst system of claim 11, wherein the first catalyst component is selected from dimethylsilylbis(2-methyl-4-phenyl-indenyl)zirconium dichloride, dimethylsilylbis(2-methyl-indenyl)zirconium dichloride, dimethylsilylbis(2-methyl-4,5-benzo-indenyl)zirconium dichloride and combinations thereof.

14. The catalyst system of claim 11 further comprising a support material.

15. The catalyst system of claim 14 wherein the first catalyst component and second catalyst component are supported on the same support material.

16. The catalyst system of claim 14 wherein the first catalyst component is supported on a first support material and the second catalyst component is supported on a second support material.

17. The catalyst system of claim 14 wherein the support material is silica.

18. The process of claim 1 wherein the first catalyst component and the second catalyst component are supported on a support material.

19. The process of claim 1 wherein the first catalyst component is supported on a first support material to form a supported first catalyst component, and the second catalyst component is supported on a second support material to form a supported second catalyst component, and the supported first catalyst component is mixed with the supported second catalyst component.

20. The process of claim 1, wherein the polymer comprises copolymers wherein the copolymer makes up from 1 wt % to 20 wt % of the polymer.
